(19) United States
(12) Patent Application Publication
(10) Pub. No.: US 2025/0197541 A1
(43) Pub. Date: Jun. 19, 2025

(54) METHOD FOR RADICAL POLYMERISATION OF THIONOLACTIDES

(71) Applicants: CENTRE NATIONAL DE LA RECHERCHE SCIENTIFIQUE, Paris (FR); UNIVERSITE TOULOUSE III - PAUL SABATIER, Toulouse Cedex 9 (FR); UNIVERSITE DE BORDEAUX, Bordeaux (FR); INSTITUT POLYTECHNIQUE DE BORDEAUX, Talence (FR)

(72) Inventors: Oleksandr IVANCHENKO, Toulouse Cedex 09 (FR); Simon HARRISSON, Pessac Cedex (FR); Mathias DESTARAC, Toulouse Cedex 09 (FR); Stéphane MAZIERES, Toulouse Cedex 09 (FR)

(73) Assignees: CENTRE NATIONAL DE LA RECHERCHE SCIENTIFIQUE, Paris (FR); UNIVERSITE TOULOUSE III - PAUL SABATIER, Toulouse Cedex 9 (FR); UNIVERSITE DE BORDEAUX, Bordeaux (FR); INSTITUT POLYTECHNIQUE DE BORDEAUX, Talence (FR)

(21) Appl. No.: 18/846,330

(22) PCT Filed: Mar. 16, 2023
(86) PCT No.: PCT/EP2023/056838

§ 371 Date: Sep. 12, 2024

(30) Foreign Application Priority Data
Mar. 17, 2022 (FR) FR2202350

(51) Int. Cl. C08F 212/08; C08F 218/10; C08F 220/14; C08F 220/18

(52) U.S. Cl. CPC C08F 212/08; C08F 218/10; C08F 220/14; C08F 220/1804; C08F 2438/03

(57) ABSTRACT

A method for preparing copolymers, preferably degradable or biodegradable copolymers, from thionolactides. More particularly, a method for preparing copolymers, preferably degradable copolymers, by ring-opening radical polymerisation, employing in particular at least one thiolactide monomer. Also, the copolymers, preferably degradable copolymers, obtained by implementing this method, to the use of the thionolactide monomer as a precursor monomer in a radical polymerisation, and to specific thionolactides.

The present invention relates to a method for preparing copolymers, preferably degradable or biodegradable copolymers, from thionolactides.

More particularly, the present invention is directed to a method for preparing copolymers, preferably degradable copolymers, by radical ring-opening polymerisation implementing in particular at least one thionolactide type monomer, to copolymers, preferably degradable copolymers, obtained by implementing this method, to the use of said thionolactide type monomer as a precursor monomer in radical polymerisation, as well as to specific thionolactides.

The majority of synthetic polymers are currently synthesised by radical polymerisation of vinyl monomers such as ethylene, methyl methacrylate, styrene and vinyl acetate. Radical synthesis methods have the advantage of tolerating a wide range of functionalities, thus enabling synthesis of many materials. The application of controlled radical polymerisation techniques, developed towards the end of the 20^{th} century, also enables synthesis of polymers and copolymers with complex architecture, for example block, gradient or star copolymers, with control of the mean molar mass as well as well as the molar mass distribution of the polymer.

One of the main disadvantages of polymers produced by radical polymerisation is that they are difficult to degrade. Indeed, the different monomer units are linked together by carbon-carbon (C—C) bonds, which are highly resistant to degradation. This can lead to environmental damage and also limit the application of these polymers in the medical field, where it is important to avoid accumulation of high-molecular-weight polymers in the body.

One way of introducing the property of degradability to synthetic polymers obtained by radical polymerisation is to use a cyclic comonomer that polymerises by Radical Ring-Opening Polymerisation (RROP). These monomers are mainly of two types: vinyl and exo-methylene. When the vinyl or exo-methylene type cyclic comonomer carries a degradable functionality, this can be incorporated into the polymer backbone, making it degradable.

The polymerisation of these monomers proceeds by the addition of a radical to a double bond, followed by ring opening and generation of a linear species according to the following reaction schemes (1) and (2), relating to vinyl and exo-methylene monomers respectively:

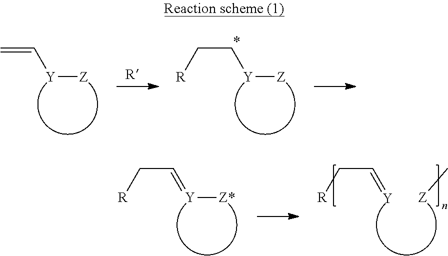

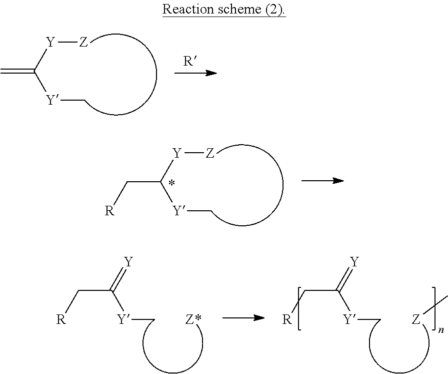

Vinyl type monomers include vinyl cyclopropanes, which were introduced in the 1960s. Exo-methylene monomers include the ketene acetals introduced in the 1980s, including in particular 2-methylene-1,3-dioxane (MDO), which is converted to an ester during free radical polymerisation [with Y=Y′=O in reaction scheme (2)]. The monomer MDO has been studied in controlled radical polymerisation, especially in Hedir et al, Biomacromolecules, 2015, 16, 2049-2058. In general, ketene acetals easily copolymerise with vinyl esters and vinyl ethers but with more difficulty with styrene monomers, (meth)acrylates and (meth)acrylamides. Moreover, they are difficult to synthesise and are often obtained in fairly low yields. Other exo-methylene type monomers such as cyclic allylic sulphides (e.g. 2-methyl-7-methylene-1,5-dithiacyclooctane) were also described.

More recently, the use of a thionolactone, dibenzo[c,e]oxepane-5-thione (DOT) was described in radical polymerisation. Copolymers of this monomer with acrylonitrile, N,N-dimethyl acrylamide, poly(ethylene glycol)methyl ether acrylate (PEGA), methyl acrylate and maleimides were prepared. However, DOT is inert in the presence of methyl methacrylate, delays the radical polymerisation of styrene without being incorporated into the polymer backbone, and inhibits polymerisation of vinyl acetate and N-vinylpyrrolidone. Additionally, its synthesis is complicated. Other thionolactones, such as γ-phenyl-γ-butyrolactone and 4-thionophthalide, were tested in copolymerisation with different monomers and found to be inert [Bingham et al, Chem. Commun., 2019, 55, 55]. Finally, Ivanchenko et al [Polymer Chemistry, 2021, 12, 1931-1938] described the use of thionocaprolactone which was found to be inert towards n-butyl acrylate.

Consequently, there is a need for synthesis methods providing simple access, preferably with good yields, to new synthetic polymers with varied structures, and preferably being degradable or even biodegradable. There is also a need for precursor monomers that can react with comonomers with various structures, for example with activated comonomers such as styrenes or acrylates, as well as with non-activated comonomers such as vinyl esters.

Surprisingly, the inventors have developed a radical ring-opening polymerisation method that makes it possible to achieve these aims, said method especially offering a wide range of reactivity.

The first object of the present invention is therefore a method for preparing at least one copolymer, preferably at least one degradable copolymer, said method comprising at least one step of radical polymerisation by ring opening of at least one cyclic monomer with at least one monomer comprising an ethylenic unsaturation, in the presence of a radical polymerisation initiator, said method being characterised in that:
(i) the cyclic monomer is selected from thionolactides of the following formula (I):

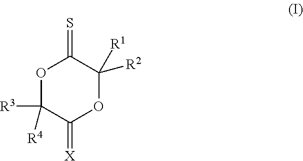

wherein:
   X is an oxygen atom or a sulphur atom;
   R¹, R², R³ and R⁴, independently of each other, represent a hydrogen atom, a halogen atom, a group selected from an alkyl radical, a haloalkyl radical, an optionally substituted phenyl radical, a cyano group (CN), an optionally substituted alkyl-phenyl radical, an optionally substituted haloalkyl-phenyl radical, a carboxylic acid radical (COOH), an ester radical CO₂R⁵ with R⁵ representing an alkyl radical, a phosphonic acid radical (PO(OH)₂), a phosphonic acid ester radical P(O)(OR^{6a})(OR^{6b}) with R^{6a} representing a hydrogen atom or an alkyl radical, and R^{6b} representing an alkyl radical, a sulphonic acid radical (SO₃H), a sulphonic acid ester radical SO₃R⁷ with R⁷ representing an alkyl radical or a haloalkyl radical, and an amide radical C(O)NR^{8a}R^{8b}, with R^{8a} and R^{8b}, independently of each other, representing a hydrogen atom or an alkyl radical, or together forming an alkyl radical;
   and in that:
(ii) the monomer including an ethylenic unsaturation is selected from the monomers of the following formula (II):

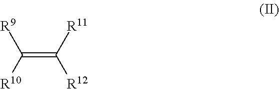

wherein:
   R⁹ represents a hydrogen atom or a fluorine atom;
   R¹⁰ represents a hydrogen atom or a fluorine atom;
   R¹¹ represents a hydrogen atom, an alkyl radical, a fluorine atom or a chlorine atom;
   R¹² represents a hydrogen atom, or a group selected from the following groups:
   an alkyl radical,
   a haloalkyl radical,
   an optionally substituted aryl radical,
   an optionally substituted alkyl-aryl radical,
   an imidazolyl group,
   an alkylimidazolium group,
   a carbazoyl group,
   a group of the following formula (III):

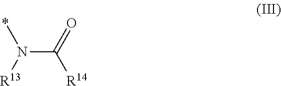

wherein the asterisk (*) represents the anchor point of the group of formula (III) to the carbon atom of the compound of formula (II), and R¹³ and R¹⁴, identical or different, represent a hydrogen atom, an alkyl radical, an optionally substituted alkyl-aryl radical, an optionally substituted aryl radical, a glycidyl group, or R¹³ and R¹⁴, together with the nitrogen and carbon atoms of the group of formula (III) to which they are bonded, form a heterocarbon ring comprising from 4 to 7 carbon atoms (including the carbon atom carrying the oxygen atom),
   a —OC(O)R¹⁵ group, with R¹⁵ representing an alkyl radical, a haloalkyl radical, an optionally substituted alkyl-aryl radical, an optionally substituted aryl radical,
   a —C(O)OR¹⁶ group, with R¹⁶ representing an alkyl radical, a haloalkyl radical, an optionally substituted alkyl-aryl radical or an optionally substituted aryl radical,
   a phosphonic acid group (PO(OH)₂),
   a phosphonic acid ester group P(O)(OR^{17a})(OR^{17b}), with R¹⁷a representing a hydrogen atom or an alkyl radical, and R^{17b} representing an alkyl radical,
   a sulphonic acid group (SO₃H),
   a sulphonic acid ester group SO₃R¹⁸, with R¹⁸ representing an alkyl radical or a haloalkyl radical, and
   an amide group C(O)NR^{19a}R^{19b}, with R^{19a} and R^{19b}, independently of each other, representing a hydrogen atom or an alkyl radical, or together forming an alkyl radical.

By virtue of this method, it is now possible to obtain copolymers in a simple manner, preferably in good yields, copolymers, preferably degradable copolymers whose degradability can be easily modulated by modifying respective proportions of the monomers of formulae (I) and (II).

During the method of the invention, ring opening of the cyclic monomer (I) makes it possible to form units within the copolymer which include thioester linkages, and ester linkages when X is an oxygen atom. Moreover, a fraction of the cyclic monomer (I) can also react by radical polymerisation with monomer (II) without ring opening. The copolymer thus obtained comprises, further to monomer units (I) with thioester linkages, and ester linkages when X is an oxygen atom, cyclic monomer units (I) with orthodithioester linkages and/or thioacetal linkages.

Degradability of the copolymer is therefore provided by the presence of thioester linkages, and optionally orthodithioester and/or thioacetal linkages, as a result of the incorporation of monomers of formula (I) into the copolymer backbone. The greater their proportion in relation to the monomers of formula (II), the greater the degradability of the copolymer. Thus, after degradation, the length of the fragments obtained is inversely proportional to the amount of monomers of formula (I) incorporated into the polymer backbone. In addition, chemical groups at the ends of the fragments obtained are functional and reactive. Furthermore, the thionolactide monomers of formula (I) implemented in the free-radical copolymerisation reaction according to the method in accordance with the invention can easily be synthesised according to conventional techniques known to the person skilled in the art from non-sulphur precursors such as commercially available α-hydroxy acids, to form lactides which give thiolactides by thionation. In addition, monomers (I) have the ability to react both with activated monomers such as styrene, its derivatives or acrylates and with non-activated monomers such as vinyl esters. Finally, most monomers of formula (II) are commercially available.

Monomer (I) of the invention is different from monomers known in prior art such as thionolactide (or dithionolactide) which contains an —S(C═O)— unit. Dithionolactide therefore does not contain a C═S thiocarbonyl linkage. This cyclic di(thioester) can be polymerised by non-radical ring opening, using basic catalysis, to produce degradable poly(thioesters). This monomer cannot be copolymerised by a radical route with a comonomer (II) of the invention.

According to the present invention, by degradable polymer, it is meant a polymer whose backbone includes bonds that can be easily broken, especially by chemical hydrolysis, by aminolysis or by enzymatic digestion, to lead to smaller and possibly less polluting molecules. According to the invention, said linkages are in particular thioester linkages, and optionally orthodithioester and/or thioacetal linkages.

According to the invention, the term “thionolactide monomers of formula (I)” includes the thionolactide as such corresponding to the compound of formula (I) wherein R¹, R³=H, and R², R⁴=CH₃; as well as any derivative of the aforementioned thionolactide corresponding to any of the compounds of formula (I) wherein R¹, R², R³, R⁴ are as defined in the invention.

### The Thionolactide Monomers (I)

X is an oxygen atom or a sulphur atom, and preferably an oxygen atom.

R¹, R², R³, and R⁴, independently of each other, represent a hydrogen atom, a halogen atom, a group selected from an alkyl radical, a haloalkyl radical, an optionally substituted phenyl radical, a cyano group (CN), an optionally substituted alkyl-phenyl radical, an optionally substituted haloalkyl-phenyl radical, a carboxylic acid radical (COOH), an ester radical CO₂R⁵ with R⁵ representing an alkyl radical, a phosphonic acid radical (PO(OH)₂), a phosphonic acid ester radical P(O)(OR^{6a}R^{6b})₂ with R^{6a} representing a hydrogen atom or an alkyl radical, and R^{6b} representing an alkyl radical, a sulphonic acid radical (SO₃H), a sulphonic acid ester radical SO₃R⁷ with R⁷ representing an alkyl radical or a haloalkyl radical, and an amide radical C(O)NR^{8a}R^{8b}, with R^{8a} and R^{8b}, independently of each other, representing a hydrogen atom or an alkyl radical, or together forming an alkyl radical.

The halogen atom as the R¹, R², R³ and/or R⁴ group is preferably a fluorine atom.

The alkyl radical as the R¹, R², R³, and/or R⁴ group may be linear or branched, cyclic or non-cyclic. The alkyl radical is preferably linear and non-cyclic. The alkyl radical may comprise from 1 to 22 carbon atoms, preferably from 1 to 6 carbon atoms, and particularly preferably from 1 to 3 carbon atoms. An alkyl radical is advantageously a methyl or ethyl group.

In the invention, the term “haloalkyl” means an alkyl radical comprising one or more halogen atoms, preferably selected from chlorine and fluorine atoms.

The haloalkyl radical as the group R¹, R², R³, and/or R⁴ may be linear or branched, cyclic or non-cyclic. The haloalkyl radical is preferably linear and non-cyclic. The haloalkyl radical may comprise from 1 to 18 carbon atoms, preferably from 1 to 6 carbon atoms, and particularly preferably from 1 to 3 carbon atoms. A haloalkyl radical is advantageously a trifluoromethyl, fluoromethyl, chloromethyl or chloroethyl group.

In the invention, the term “optionally substituted phenyl” means that the phenyl radical as the group R¹, R², R³ and/or R⁴ may be substituted with one or more substituents such as halogen atoms, preferably selected from chlorine and fluorine atoms, alkyl groups and haloalkyl groups.

The haloalkyl group as a substituent for the phenyl radical preferably comprises from 1 to 3 carbon atoms. Advantageously, it is a trifluoromethyl group.

The alkyl group as a substituent for the phenyl radical preferably comprises from 1 to 3 carbon atoms. It is advantageously a methyl group.

The phenyl radical substituted with one or more halogen atoms is preferably a pentafluorinated phenyl radical —C₆F₅.

An optionally substituted alkyl-phenyl radical as a R¹, R², R³ and/or R⁴ group is a radical comprising at least one alkyl radical and at least one optionally substituted phenyl radical which are directly linked via a covalent carbon (of the optionally substituted phenyl radical)-carbon (of the alkyl radical) bond, the optionally substituted phenyl and alkyl radicals being as defined previously for the R¹, R², R³ and R⁴ groups. The alkyl radical is directly linked via a carbon atom to the thionolactide. An optionally substituted alkyl-phenyl radical is advantageously a benzyl or pentafluorobenzyl radical.

An optionally substituted haloalkyl-phenyl radical as a R¹, R², R³ and/or R⁴ group is a radical comprising at least one haloalkyl radical and at least one optionally substituted phenyl radical which are directly linked by a carbon (of the optionally substituted phenyl radical)-carbon (of the haloalkyl radical) covalent bond, the optionally substituted phenyl and haloalkyl radicals being as defined previously for the R¹, R², R³ and R⁴ groups. The haloalkyl radical is directly linked via a carbon atom to the thionolactide.

The alkyl radical as the R⁵ group may be linear or branched, cyclic or non-cyclic. The alkyl radical is preferably linear and non-cyclic. The alkyl radical may comprise from 1 to 22 carbon atoms, preferably from 1 to 6 carbon atoms, and particularly preferably from 1 to 3 carbon atoms. An alkyl radical is advantageously a methyl or ethyl group.

The alkyl radical as the R^{6a} or R^{6b} group may be linear or branched, cyclic or non-cyclic. The alkyl radical is preferably linear and non-cyclic. The alkyl radical may comprise from 1 to 22 carbon atoms, preferably from 1 to 6 carbon atoms, and particularly preferably from 1 to 3 carbon atoms. An alkyl radical is advantageously a methyl or ethyl group.

The alkyl radical as the R⁷ group may be linear or branched, cyclic or non-cyclic. The alkyl radical is preferably linear and non-cyclic. The alkyl radical may comprise from 1 to 22 carbon atoms, preferably from 1 to 6 carbon atoms, and particularly preferably from 1 to 3 carbon atoms. An alkyl radical is advantageously a methyl or ethyl group.

The haloalkyl radical as the R⁷ group may be linear or branched, cyclic or non-cyclic. The haloalkyl radical is preferably linear and non-cyclic. The haloalkyl radical may comprise from 1 to 18 carbon atoms, preferably from 1 to 6 carbon atoms, and particularly preferably from 1 to 3 carbon atoms. A haloalkyl radical is advantageously a trifluoromethyl group.

The alkyl radical as the R^{a} or R^{8b} group may be linear or branched, cyclic or non-cyclic. The alkyl radical is preferably linear and non-cyclic. The alkyl radical may comprise from 1 to 22 carbon atoms, preferably from 1 to 6 carbon atoms, and particularly preferably from 1 to 3 carbon atoms. An alkyl radical is advantageously a methyl or ethyl group.

When the R^{8a} and R^{8b} groups together form an alkyl radical, a nitrogen ring is obtained in which R^{8a} and R^{8b} together form an alkyl radical, in particular comprising 5 carbon atoms (piperidine ring).

Modulation of the R¹, R², R³ and R⁴ groups of the thionolactide (I) allows increase of its reactivity towards non-activated monomers (II) such as, for example, monomers of the vinyl ester type, or towards activated monomers (II) such as, for example, monomers of the acrylate, acrylamide or styrene type, etc.

R¹, R², R³ and R⁴, independently of each other, preferably represent a hydrogen atom, a halogen atom, a group selected from an alkyl radical, a haloalkyl radical, an optionally substituted phenyl radical, an optionally substituted alkyl-phenyl radical and an optionally substituted haloalkyl-phenyl radical, and particularly preferably a hydrogen atom, a halogen atom, an alkyl radical, a haloalkyl radical and an optionally substituted phenyl radical.

According to a preferred embodiment of the invention:
R¹=H or CH₃,
R²=H, CH₃, C₆H₅, CF₃, C₆F₅, C₆H₄—CF₃, F, CH₂F, CH₂Cl or C₂H₄—Cl,
R³=H or CH₃,
R⁴=H, CH₃, C₆H₅, CF₃, C₆F₅, C₆H₄—CF₃, F, CH₂F, CH₂Cl, or C₂H₄—Cl.

The thionolactide of formula (I) is advantageously selected from the following thionolactides:
(i) the thionolactides in which R² and R⁴ are as defined in the invention to the exclusion of hydrogen atoms, and particularly preferably are alkyl radicals,
(ii) the thionolactides in which R³ and R⁴ are as defined in the invention, to the exclusion of hydrogen atoms, and particularly preferably are alkyl radicals, and
(iii) the thionolactides in which R¹, R², R³ or R⁴ are hydrogen atoms.

In thionolactides (i), R¹ and R³ are preferably hydrogen atoms.

In thionolactides (ii), R¹ and R² are preferably hydrogen atoms.

Thionolactides (i) and (ii) promote copolymerisation with the activated monomers (II).

Thionolactides (iii) promote copolymerisation with the non-activated monomers (II).

According to a particular embodiment of the invention, all the R¹ and R² groups are identical to all the R³ and R⁴ groups. This leads to a “symmetrical” thionolactide (I) which is easier to prepare.

Thionolactides of formula (I) are advantageously selected from thionolactides of formulae (I-1) to (I-13) shown in the following Table 1:

TABLE 1

| | |
|---|---|
| 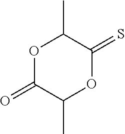 | (I-1) |
| 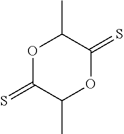 | (I-2) |
| 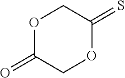 | (I-3) |
| 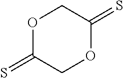 | (I-4) |
| 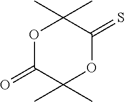 | (I-5) |
| 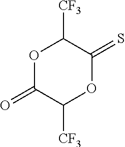 [SMILES: O=C1OC(C(F)(F)F)C(=S)OC1C(F)(F)F] | (I-6) |
| 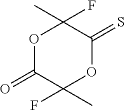 | (I-7) |
| 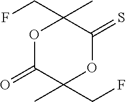 | (I-8) |
| 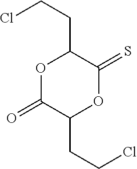 [SMILES: O=C1OC(CCCl)C(=S)OC1CCCl] | (I-9) |
| 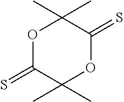 | (I-10) |
| 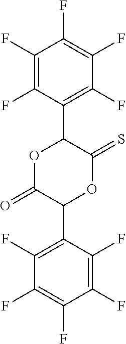 [SMILES: O=C1OC(c2c(F)c(F)c(F)c(F)c2F)C(=S)OC1c1c(F)c(F)c(F)c(F)c1F] | (I-11) |
| 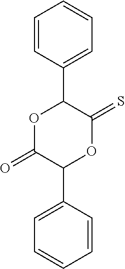 [SMILES: O=C1OC(c2ccccc2)C(=S)OC1c1ccccc1] | (I-12) |
| 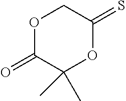 | (I-13) |
| 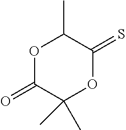 | (I-14) |

Of these thionolactides of formulae (I-1) to (I-14), the thionolactides of formulae (I-1), (I-13) and (I-14) are particularly preferred.

### The Monomers (II)

R⁹ preferably represents a hydrogen atom.

R¹⁰ preferably represents a hydrogen atom.

R¹¹ preferably represents a hydrogen atom or an alkyl radical.

The alkyl radical as the group R¹¹ may be linear or branched, cyclic or non-cyclic. The alkyl radical is preferably linear and non-cyclic. The alkyl radical may comprise from 1 to 5 carbon atoms, and preferably from 1 to 3 carbon atoms. An alkyl radical is advantageously a methyl group.

The alkyl radical as the group R¹² may be linear or branched, cyclic or non-cyclic. The alkyl radical is preferably linear and non-cyclic. The alkyl radical may include from 1 to 22 carbon atoms, preferably from 1 to 10 carbon atoms, and particularly preferably from 1 to 5 carbon atoms, said alkyl radical being optionally substituted with a hydroxyl radical.

As examples of alkyl radicals as the R¹² group, the following radicals may be mentioned: methyl, ethyl, iso-propyl, n-butyl, 2-butyl, iso-butyl, tert-butyl, npentyl, iso-pentyl, neo-pentyl, tert-pentyl, 2-methylbutyl, hexyl, n-octyl, iso-octyl, 2-ethyl-1-hexyl, 2,2,4-trimethylpentyl, nonyl, neo-decanyl, decyl, dodecyl, octadecyl, behenyl or cyclohexylmethyl, and preferably the methyl or hexyl radical.

The haloalkyl radical as the group R¹² may be linear or branched, cyclic or non-cyclic. The haloalkyl radical is preferably linear and non-cyclic. The haloalkyl radical may comprise from 1 to 22 carbon atoms, and preferably from 1 to 5 carbon atoms.

The aryl radical as the R¹² group may be a monocyclic or polycyclic aromatic hydrocarbon group, optionally substituted with an alkyl radical comprising from 1 to 5 carbon atoms, or an alkoxyl radical comprising from 1 to 5 carbon atoms.

As examples of aryl radicals as the R¹² group, mention may in particular be made of phenyl, trityl, naphthalenyl, anthracenyl and pyrenyl radicals. Among such radicals, the phenyl radical is particularly preferred.

The optionally substituted alkyl-aryl radical as the group R¹² is a radical comprising at least one alkyl radical and at least one optionally substituted aryl radical which are directly linked via a covalent carbon (of the optionally substituted aryl radical)-carbon (of the alkyl radical) bond, the optionally substituted aryl and alkyl radicals being as defined previously for the group R¹². The alkyl radical is directly linked via a carbon atom to the ethylene function (double bond) of the monomer (II). An optionally substituted alkyl-aryl radical is advantageously a benzyl, p-methoxybenzyl or pentafluorobenzyl radical.

The alkyl substituent of the alkylimidazolium radical as the group R¹² preferably comprises from 1 to 16 carbon atoms, and particularly preferably from 1 to 5 carbon atoms. The alkylimidazolium radical as the R¹² group preferably comprises a counterion selected from Br⁻, BF₄⁻, and PF₆⁻.

### Group of Formula (III)

The alkyl radical as the R¹³ and/or R¹⁴ group may be linear or branched, cyclic or non-cyclic. The alkyl radical is preferably linear. The alkyl radical may include from 1 to 22 carbon atoms, and preferably from 1 to 5 carbon atoms.

As examples of alkyl radicals as the group R¹³ and/or R¹⁴, the following radicals may be mentioned: methyl, ethyl, iso-propyl, n-butyl, 2-butyl, iso-butyl, tert-butyl, npentyl, iso-pentyl, neo-pentyl, tert-pentyl, 2-methylbutyl, hexyl, noctyl, iso-octyl, 2-ethyl-1-hexyl, 2,2,4-trimethylpentyl, nonyl, neo-decanyl, decyl, dodecyl, octadecyl, behenyl, cyclohexylmethyl, adamantyl and cyclohexyl.

The aryl radical as the R¹³ and/or R¹⁴ group may be a monocyclic or polycyclic aromatic hydrocarbon group, optionally substituted with an alkyl radical comprising from 1 to 5 carbon atoms, or an alkoxyl radical comprising from 1 to 5 carbon atoms.

As examples of an aryl radical as the R¹³ and/or R¹⁴ group, mention may in particular be made of the phenyl, trityl, naphthalenyl, anthracenyl and pyrenyl radicals. Among such radicals, the phenyl radical is particularly preferred.

The optionally substituted alkyl-aryl radical as the R¹³ and/or R¹⁴ group is a radical comprising at least one alkyl radical and at least one optionally substituted aryl radical which are directly linked via a covalent carbon (of the optionally substituted aryl radical)-carbon (of the alkyl radical) bond, the optionally substituted aryl and alkyl radicals being as defined previously for the R¹³ and R¹⁴ groups. The alkyl radical is directly linked via a carbon atom to the nitrogen atom of the formula (III) for R¹³ and to the carboxyl function of the formula (III) for R¹⁴. An optionally substituted alkyl-aryl radical is advantageously a benzyl or pentafluorobenzyl radical.

When R¹³ and R¹⁴, together with the nitrogen and carbon atoms of the group of formula (III) to which they are bonded, form a heterocarbon ring, this can especially be a pyrrolidone, piperidone or caprolactam ring.

According to a preferred embodiment of the invention, R¹³ and R¹⁴, identical or different, represent a hydrogen atom or an alkyl radical, or R¹³ and R¹⁴, together with the nitrogen and carbon atoms of the group of formula (III) to which they are bonded, form a heterocarbon ring comprising from 4 to 7 carbon atoms (including the carbon atom carrying the oxygen atom).

According to a particularly preferred embodiment, R¹³ and R¹⁴ are identical and represent a methyl radical or, together with the nitrogen and carbon atoms of the group of formula (III) to which they are bonded, form a pyrrolidone or caprolactam ring.

### —OC(O)R¹⁵ Group

The alkyl radical as the R¹⁵ group may be linear or branched, cyclic or non-cyclic. The alkyl radical is preferably linear and non-cyclic. The alkyl radical may include from 1 to 22 carbon atoms, and preferably from 1 to 5 carbon atoms.

As examples of alkyl radicals as the R¹⁵ group, the following radicals may be mentioned: methyl, ethyl, iso-propyl, n-butyl, 2-butyl, iso-butyl, tert-butyl, npentyl, iso-pentyl, neo-pentyl, tert-pentyl, 2-methylbutyl, hexyl, n-octyl, isooctyl, 2-ethyl-1-hexyl, 2,2,4-trimethylpentyl, nonyl, neo-decanyl, decyl, dodecyl, octadecyl, behenyl, cyclohexylmethyl, adamantyl and cyclohexyl.

The aryl radical as the R¹⁵ group may be a monocyclic or polycyclic aromatic hydrocarbon group, optionally substituted with an alkyl radical comprising from 1 to 5 carbon atoms, or an alkoxyl radical comprising from 1 to 5 carbon atoms.

As examples of aryl radicals as the R¹⁵ group, mention may in particular be made of phenyl, trityl, naphthalenyl, anthracenyl and pyrenyl radicals. Among such radicals, the phenyl radical is particularly preferred.

The optionally substituted alkyl-aryl radical as the group R¹⁵ is a radical comprising at least one alkyl radical and at least one optionally substituted aryl radical which are directly linked via a covalent carbon (of the optionally substituted aryl radical)-carbon (of the alkyl radical) bond, the optionally substituted aryl and alkyl radicals being as previously defined for the R¹⁵ group. The alkyl radical is directly linked via a carbon atom to the carbon atom of the ester function. An optionally substituted alkyl-aryl radical is advantageously a benzyl or pentafluorobenzyl radical.

The haloalkyl radical as the R¹⁵ group may be linear or branched, cyclic or non-cyclic. The haloalkyl radical is preferably linear and non-cyclic. The haloalkyl radical may comprise from 1 to 22 carbon atoms, and preferably from 1 to 5 carbon atoms.

R¹⁵ preferably represents an alkyl or haloalkyl radical, and particularly preferably an alkyl radical such as a methyl or t-butyl radical.

### —C(O) OR¹⁶ GROUP

The alkyl radical as the R¹⁶ group may be linear or branched, cyclic or non-cyclic. The alkyl radical is preferably linear and non-cyclic. The alkyl radical may include from 1 to 22 carbon atoms, and preferably from 1 to 5 carbon atoms.

As examples of alkyl radicals as the R¹⁶ group, the following radicals may be mentioned: methyl, ethyl, iso-propyl, n-butyl, 2-butyl, iso-butyl, tert-butyl, npentyl, iso-pentyl, neo-pentyl, tert-pentyl, 2-methylbutyl, hexyl, n-octyl, isooctyl, 2-ethyl-1-hexyl, 2,2,4-trimethylpentyl, nonyl, neo-decanyl, decyl, dodecyl, octadecyl, behenyl, isobornyl, cyclohexylmethyl, adamantyl and cyclohexyl.

The aryl radical as the R¹⁶ group may be a monocyclic or polycyclic aromatic hydrocarbon group, optionally substituted with an alkyl radical comprising from 1 to 5 carbon atoms, or an alkoxyl radical comprising from 1 to 5 carbon atoms.

As examples of aryl radical as the R¹⁶ group, mention may in particular be made of the phenyl, trityl, naphthalenyl, anthracenyl and pyrenyl radicals. Among such radicals, the phenyl radical is particularly preferred.

The optionally substituted alkyl-aryl radical as the group R¹⁶ is a radical comprising at least one alkyl radical and at least one optionally substituted aryl radical which are directly linked via a covalent carbon (of the optionally substituted aryl radical)-carbon (of the alkyl radical) bond, the optionally substituted aryl and alkyl radicals being as defined previously for the group R¹⁶. The alkyl radical is directly linked via a carbon atom to the carbon atom of the ester function. An optionally substituted alkyl-aryl radical is advantageously a benzyl or pentafluorobenzyl radical.

The haloalkyl radical as the R¹⁶ group may be linear or branched, cyclic or non-cyclic. The haloalkyl radical is preferably linear and non-cyclic. The haloalkyl radical may comprise from 1 to 22 carbon atoms, and preferably from 1 to 5 carbon atoms.

R¹⁶ preferably represents an alkyl radical, and in particular a methyl or t-butyl radical.

The alkyl radical as the R^{17a} or R^{17b} group may be linear or branched, cyclic or non-cyclic. The alkyl radical is preferably linear and non-cyclic. The alkyl radical may comprise from 1 to 22 carbon atoms, preferably from 1 to 6 carbon atoms, and particularly preferably from 1 to 3 carbon atoms. An alkyl radical is advantageously a methyl or ethyl group.

The alkyl radical as the R¹⁸ group may be linear or branched, cyclic or non-cyclic. The alkyl radical is preferably linear and non-cyclic. The alkyl radical may comprise from 1 to 22 carbon atoms, preferably from 1 to 6 carbon atoms, and particularly preferably from 1 to 3 carbon atoms. An alkyl radical is advantageously a methyl or ethyl group.

The haloalkyl radical as an R¹⁸ group may be linear or branched, cyclic or non-cyclic. The haloalkyl radical is preferably linear and non-cyclic. The haloalkyl radical may comprise from 1 to 18 carbon atoms, preferably from 1 to 6 carbon atoms, and particularly preferably from 1 to 3 carbon atoms. A haloalkyl radical is advantageously a trifluoromethyl group.

The alkyl radical as the R^{19a} or R^{19b} group may be linear or branched, cyclic or non-cyclic. The alkyl radical is preferably linear and non-cyclic. The alkyl radical may comprise from 1 to 22 carbon atoms, preferably from 1 to 6 carbon atoms, and particularly preferably from 1 to 3 carbon atoms. An alkyl radical is advantageously a methyl or ethyl group.

When the R^{19a} and R^{19b} groups together form an alkyl radical, a nitrogen ring is obtained in which R^{19a} and R^{19b} together form an alkyl radical, in particular comprising 5 carbon atoms (piperidine ring).

According to a particular embodiment, the monomer of formula (II) is selected from:
the vinyl ester type monomers represented by the following formula (II-1):

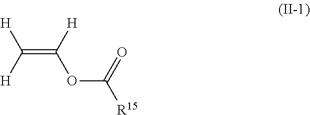

wherein R¹⁵ is as defined in the invention,
the α-olefin type monomers represented by the following formula (II-2):

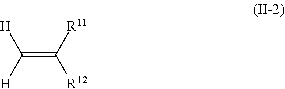

wherein R¹¹ represents a hydrogen atom or an alkyl radical as defined in the invention, and R¹² represents an alkyl radical or an optionally substituted aryl radical as defined in the invention,
the N-vinyl type monomers represented by the following formula (III-1):

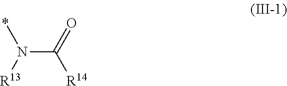

wherein R¹³ and R¹⁴ are as defined in the invention,
the acrylate and alkacrylate monomers represented by the following formula (II-3):

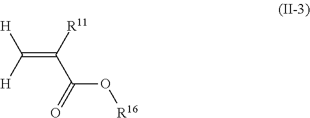

wherein R¹¹ represents a hydrogen atom or an alkyl radical as defined in the invention, and R¹⁶ represents an alkyl radical as defined in the invention.

Among the monomers of formula (II-1), mention may be made of vinyl acetate, vinyl pivalate, vinyl trifluoroacetate, vinyl chloroacetate, vinyl propionate, vinyl butyrate, vinyl neodecanoate (R¹⁵=C₉H₁₉, mixture of isomers) and vinyl trifluorobutyrate. Among these monomers of formula (II-1), vinyl acetate and vinyl pivalate are particularly preferred.

Monomers of formula (II-2) include ethylene and octene. Ethylene is particularly preferred.

Among the monomers of formula (III-1), mention may in particular be made of acyclic N-vinyl monomers such as N-vinylformamide, N-vinylacetamide and N-methyl-N-vinylacetamide, as well as cyclic N-vinyl monomers, (when R¹³ and R¹⁴ form a heterocarbon ring together with the nitrogen and carbon atoms of the group of formula (III-1) to which they are bonded) such as N-vinylpyrrolidone, Nvinylpiperidone, and N-vinylcaprolactam. Among such monomers of formula (III-1), N-vinylacetamide and N-vinylpyrrolidone are particularly preferred.

Among the monomers of formula (II-3), particular mention may be made of methyl acrylate, n-butyl acrylate, tert-butyl acrylate, 2-ethylhexyl acrylate, methyl methacrylate, tert-butyl methacrylate, isobornyl methacrylate or adamantyl methacrylate.

According to the method in accordance with the invention, the proportion of monomers of formula (I) is preferably selected such that the monomer or monomers of formula (I) represent at most 50% by number relative to the total number of monomers of formulae (I) and (II). According to a particularly preferred embodiment, the monomer or monomers of formula (I) represent from about 5 to 30% by number, and even more preferably from about 10 to 20% by number, relative to the total number of monomers of formulae (I) and (II). Indeed, when the proportion of monomers of formula (I) is less than 5% by number, the degradability rate of the polymer is not high, which is of little interest compared with non-degradable polymers. When the proportion of monomers of formula (I) is greater than 30% by number, the radical polymerisation method by ring opening is impaired, in particular slowed down.

For the purposes of the present invention, by radical polymerisation initiator, it is meant a chemical species capable of forming free radicals, i.e. radicals having one or more unpaired electrons on their outer shell.

According to the method in accordance with the invention, the radical polymerisation initiator is preferably selected from organic peroxides and hydroperoxides, azo derivatives and radical-generating oxidation-reduction pairs (redox systems).

Among the organic peroxides and hydroperoxides, particular mention may be made of dilauroyl peroxide (LPO), t-butyl peroxyacetate, t-butyl peroxybenzoate, t-butyl peroxyoctoate, t-butyl peroxydodecanoate, t-butyl peroxyisobutyrate, t-amyl peroxypyvalate, t-butyl peroxypyvalate, di-isopropyl peroxydicarbonate, dicyclohexyl peroxydicarbonate, dicumyl peroxide, dibenzoyl peroxide, potassium peroxydisulphate, sodium peroxydisulphate, ammonium peroxydisulphate, cumene hydroperoxide and t-butyl hydroperoxide. Of these organic peroxides, LPO and t-butyl hydroperoxide are particularly preferred.

Among the azo derivatives, particular mention may be made of 2,2′-azobis(isobutyronitrile) or AIBN, 2,2′-azobis(2-cyano-2-butane), dimethyl-2,2′-azobisdimethylisobutyrate, 4,4′-azobis-(4-cyanopentanoic acid), 1,1′-azobis(cyclohexanecarbonitrile), 2-(t-butylazo)-2-cyanopropane, 2,2′-azobis-[2-methylN(1,1)-bis(hydroxymethyl)-2-hydroxyethyl]propanamide, 2,2′-azobis-[2-methyl-N-hydroxyethyl]propanamide, 2,2′-azobis-(N,N′-dimethyleneisobutyramidine) dihydrochloride, 2,2′-azobis-(2-amidinopropane) dihydrochloride, 2,2′-azobis-(N,N′-dimethyleneisobutyramine), 2,2′-azobis-(2-methyl-N-[1,1bis(hydroxymethyl)-2-hydroxyethyl]propionamide), 2,2′-azobis-(2-methyl-N-[1,1-bis-(hydroxymethyl)propionamide], 2,2′-azobis-[2-methyl-N-(2-hydroxyethypropionamide], 2,2′-azobis-(isobutyramide)dihydrate, 2,2′-azobis-(2,2,4-trimethylpentane) and 2,2′-azobis-(2-methylpropane). Among these azo derivatives, 2,2′-azobis(isobutyronitrile) and 1,1′-azobis-(cyclohexanecarbonitrile) are particularly preferred.

The redox systems are selected, for example, from systems including combinations such as:
mixtures of hydrogen peroxide, dialkyl peroxide, a hydroperoxide, a perester, a percarbonate and similar compounds and an iron salt, a titanium salt, zinc formaldehyde sulphoxylate or sodium formaldehyde sulphoxylate, and a reducing sugar,
mixtures of an alkali metal or ammonium persulphate, perborate or perchlorate with an alkali metal bisulphite, such as sodium metabisulphite, and a reducing sugar, and
mixtures of an alkali metal persulphate with an arylphosphinic acid, such as benzene phosphonic acid and the like, and a reducing sugar.

Among such redox systems, associations of ammonium persulphate and sodium formaldehyde sulphoxylate, and of tert-butyl hydroperoxide and ascorbic acid are particularly preferred.

It is also possible to use a photochemical initiator in the ultraviolet (UV) or visible light. Examples of UV initiators include 2,2-dimethoxy-2-phenylacetophenone, benzophenone/amine or benzophenone/alcohol pairs. Thioxanthones can be used as visible initiators. Finally, some xanthate or trithiocarbonate type RAFT control agents can also be used, which are also good photochemical initiators in the UV and visible range.

The amount of radical polymerisation initiator to be used according to the method in accordance with the present invention is generally determined so that the amount of radicals generated is at most about 5 mol % relative to the total amount of monomers of formulae (I) and (II), and preferably at most about 1 mol %.

The step of radical polymerisation by ring opening of the monomers of formulae (I) and (II) can be carried out in bulk manner (without solvent) or in solution in a solvent, especially selected so that the reaction medium remains homogeneous throughout the polymerisation reaction. In general, the solvent is organic, but it is not impossible to use an aqueous solvent such as water or a mixture of water and a co-solvent if this is justified by the solubility of the monomer(s). Polymerisation of the monomers of formulae (I) and (II) can also be conducted in a heterogeneous medium, the polymer formed being insoluble in the reaction medium. Polymerisation can also be conducted by precipitation, or in dispersion, emulsion or suspension.

According to a preferred embodiment of the invention, water, hydroalcoholic mixtures or organic solvents are used as the reaction medium. Organic solvents are preferred.

The total amount of polymerisable material in the reaction medium (total amount of monomers of formula (I) and formula (II)) can be 100% when the polymerisation is carried out in a bulk manner, i.e. without solvent. When the polymerisation is carried out in a solvent, this total amount may range from about 10% to 90% by mass relative to the total mass of the reaction medium, preferably from about 20% to 80% by mass, and even more preferably from about 30% to 60% relative to the total mass of the reaction medium.

The polymerisation step of the method in accordance with the invention can be carried out at a temperature ranging from about 5 to 150° C., depending on the nature of the monomers of formulae (I) and (II) used during the reaction. According to a preferred embodiment of the method of the invention, the polymerisation step is carried out at a temperature ranging from about 20 to 130° C., and even more preferably ranging from about 40 to 110° C.

The duration of the polymerisation step generally ranges from about 1 to 12 hours, and even more preferably from about 2 to 8 hours.

As previously indicated, the polymerisation step is preferably conducted solely in the presence of the monomers of formulae (I) and (II) and a radical polymerisation initiator, i.e. without a polymerisation control agent. However, according to an alternative to the method in accordance with the invention, it is nevertheless possible to implement the polymerisation step in the presence of a polymerisation control agent, thus providing access to copolymers, preferably degradable copolymers, block, composition gradient, comb, star grafted or even hyperbranched copolymers. Indeed, different controlled radical polymerisation methods are known, making it possible to obtain polymers with controlled architecture and mass. These methods are defined according to the chemical nature of the control agents involved. The present invention can involve a control agent for controlled radical polymerisation technologies using Reversible Addition-Fragmentation Chain Transfer (RAFT), especially in the presence of xanthates (Macromolecular Design by Interchange of Xanthates (MADIX)), Atom Transfer Radical Polymerisation (ATRP), Iodine Transfer Polymerisation (ITP), Reversible Chain Transfer-catalysed radical Polymerisation (RCTP), Tellurium-mediated Radical Polymerisation (TERP), Cobalt-Mediated radical Polymerisation (CoMP), or Reversible Coordination-Mediated Polymerisation (RCMP). These different technologies are described in Polymer Chemistry 2018, 9, 4947-4967 and references cited therein.

The method of the invention thus leads to a copolymer having at least thioester linkages that are easily degradable.

In said method implementing a cyclic monomer (I) with at least one monomer including an ethylenic unsaturation (II) in the presence of a radical polymerisation initiator, a fraction of the cyclic monomer (I) can also be consumed during polymerisation without ring opening taking place. The copolymer thus obtained comprises, in addition to ring-opening thioester linkages, cyclic monomer (I) units with orthodithioester and/or thioacetal linkages. These cyclic monomer units (I) with orthodithioester and/or thioacetal linkages have the advantage of being sensitive to chemical attack and therefore potentially degradable.

The degradable copolymers obtained by implementation of the method in accordance with the present invention are novel per se and as such constitute the second object of the invention.

The second object of the present invention is therefore also a copolymer, preferably a degradable copolymer, said copolymer being characterised in that it comprises at least thioester linkages, and that it results from the radical polymerisation by ring opening:
(i) of at least one cyclic monomer selected from thionolactides of the following formula (I):

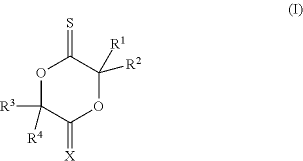

wherein:
   X is an oxygen atom or a sulphur atom;
   R¹, R², R³ and R⁴, independently of each other, represent a hydrogen atom, a halogen atom, a group selected from an alkyl radical, a haloalkyl radical, an optionally substituted phenyl radical, a cyano group (CN), an optionally substituted alkyl-phenyl radical, an optionally substituted haloalkyl-phenyl radical, a carboxylic acid radical (COOH), an ester radical CO₂R⁵ with R⁵ representing an alkyl radical, a phosphonic acid radical (PO(OH)₂), a phosphonic acid ester radical P(O)(OR^{6a})(OR^{6b}) with R^{6a} representing a hydrogen atom or an alkyl radical, and R^{6b} representing an alkyl radical, a sulphonic acid radical (SO₃H), a sulphonic acid ester radical SO₃R⁷ with R⁷ representing an alkyl radical or a haloalkyl radical, and an amide radical C(O)NR^{8a}R^{8b}, with R^{8a} and R^{8b}, independently of each other, representing a hydrogen atom or an alkyl radical, or together forming an alkyl radical; and
(ii) of at least one monomer including an ethylenic unsaturation selected from the monomers of formula (II) below:

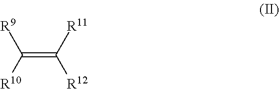

wherein:
   R⁹ represents a hydrogen atom or a fluorine atom;
   R¹⁰ represents a hydrogen atom or a fluorine atom;
   R¹¹ represents a hydrogen atom, an alkyl radical, a fluorine atom or a chlorine atom;
   R¹² represents a hydrogen atom, or a group selected from the following groups:
   an alkyl radical,
   a haloalkyl radical,
   an optionally substituted aryl radical,
   an optionally substituted alkyl-aryl radical,
   an imidazolyl group,
   an alkylimidazolium group,
   a carbazoyl group,
   a group of the following formula (III):

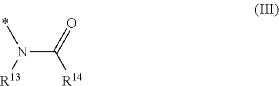

wherein the asterisk (*) represents the anchor point of the group of formula (III) to the carbon atom of the compound of formula (II), and R¹³ and R¹⁴, identical or different, represent a hydrogen atom, an alkyl radical, an optionally substituted alkyl-aryl radical, an optionally substituted aryl radical, a glycidyl group, or R¹³ and R¹⁴, together with the nitrogen and carbon atoms of the group of formula (III) to which they are bonded, form a heterocarbon ring comprising from 4 to 7 carbon atoms (including the carbon atom carrying the oxygen atom),
   a —OC(O)R¹⁵ group, with R¹⁵ representing an alkyl radical, a haloalkyl radical, an optionally substituted alkyl-aryl radical, an optionally substituted aryl radical,
   a —C(O)OR¹⁶ group, with R¹⁶ representing an alkyl radical, a haloalkyl radical, an optionally substituted alkyl-aryl radical or an optionally substituted aryl radical,
   a phosphonic acid group (PO(OH)₂),
   a phosphonic acid ester group P(O)(OR^{17a})(OR^{17b}), with R^{17a} representing a hydrogen atom or an alkyl radical, and R^{17b} representing an alkyl radical,
   a sulphonic acid group (SO₃H),
   a sulphonic acid ester group SO₃R¹⁸, with R¹⁸ representing an alkyl radical or a haloalkyl radical, and
   an amide group C(O)NR^{19a}R^{19b}, with R^{19a} and R^{19b}, independently of each other, representing a hydrogen atom or an alkyl radical, or together forming an alkyl radical,
in the presence of a radical polymerisation initiator.

The preferences indicated above with reference to the first object of the invention as regards the monomers of formulae (I) and (II) also apply to the second object of the invention.

According to a particular and preferred embodiment of the invention, said copolymer results from the polymerisation of thionolactide (I-1) and vinyl acetate, styrene, tert-butyl acrylate, methyl methacrylate or vinyl pivalate.

According to a preferred embodiment of the second object of the invention, the copolymer, preferably the degradable copolymer, is a random copolymer.

According to the invention, the copolymer, preferably the degradable copolymer, preferably has a number-average molar mass of about 2,000 to 200,000 g/mol, and even more preferably of about 5,000 to 100,000 g/mol.

The polymolecularity index of the polymer, preferably the degradable polymer, in accordance with the invention preferably ranges from 1.2 to 4, and even more preferably from 1.4 to 3.

The level of thioester linkages in the main chain of the degradable copolymer in accordance with the invention is preferably at least 2% by number, preferably from 2 to 20% by number, and even more preferably from 5 to 15% by number, relative to the total number of linkages in the main chain.

The copolymer may further comprise orthodithioester and/or thioacetal linkages which are also degradable.

According to the invention, the main chain of the copolymer is meant to be the longest bond linkage, i.e. not including bonds of the side substituents.

By virtue of their degradable nature, copolymers in accordance with the present invention can be useful in all types of industry. By way of example, particular mention may be made of the biomedical field, agriculture, cosmetics, oil extraction, detergents, salting out of active products and packaging.

If the copolymers of the invention exhibit little or no degradability, they could also be useful in the medical field, especially for dental fillings, or any type of field in which it is desired to reduce shrinkage related to polymerisation.

Additionally, the third object of the invention is the use of at least one thionolactide having the formula (I) as defined in the first object of the invention as a precursor monomer in radical polymerisation.

Radical polymerisation is as defined in the first object of the invention.

Some thionolactides having the formula (I) are novel per se and constitute a fourth object of the invention.

Thus the fourth object of the invention is a thionolactide for the implementation of a method as defined in the first object of the invention, said thiolactide having the following formula (I′):

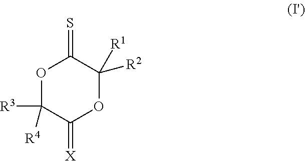

wherein:
   X, R¹, R², R³ and R⁴ are as defined in the first object of the invention,
   to the exclusion of thionolactides (I-1) and (I-2) as defined in the invention.

Preferably, the thionolactide of formula (I′) is selected from the thionolactides of formulae (I-3) to (I-14) as described in the invention.

The lactide precursors of the thionolactides of formula (I) or (I′) as described in the invention can be obtained by dimerising the corresponding alpha-hydroxy acids or, in the case of compounds (I-13) and (I-14), by reacting alpha-hydroxyisobutyric acid with chloroacetyl chloride or chloropropyl. Single or double thionation of lactides can be conducted in the presence of P₄S₁₀ and hexamethyldisiloxane (HMDSO).

### BRIEF DESCRIPTION OF THE DRAWINGS

The appended drawings illustrate the invention:

FIG. 1 illustrates the chemical degradation of a polymer CP2 in accordance with the invention.

FIG. 2 illustrates the chemical degradation of a polymer CP6 in accordance with the invention.

FIG. 3 illustrates the crystal structure of compound (I-13) used in a method in accordance with the invention.

FIG. 4 illustrates the chemical degradation of a polymer CP8 in accordance with the invention.

FIG. 5 illustrates the crystal structure of compound (I-14) used in a method in accordance with the invention.

FIG. 6 illustrates the chemical degradation of a polymer CP10 in accordance with the invention.

Further characteristics and advantages of the present invention will become apparent from the description of the examples set forth hereinafter, to which the invention is not, however, limited.

### EXAMPLES

Analyses by steric exclusion chromatography have been carried out using a facility equipped with two Shodex columns (KF-805+KF-804+KF-802.5), a refractometric detector and a light scattering detector, for analysis in tetrahydrofuran (THF) at 35° C. and a flow rate of 1 mL/min.

### Example 1: Synthesis of a Degradable Copolymer CP1 Based on Styrene and Thionolactide of Formula (I-1) According to the Method of the Invention

### 1.1 First Step: Synthesis of the Thionolactide of Formula (I-1)

P₄S₁₀ (13 mmoles, 5.8 g), racemic lactide (34.9 mmoles, 5 g), hexamethyldisiloxane (HMDSO) (86.9 mmoles, 14.1 g) and 50 mL of anhydrous acetonitrile have been introduced into a two-necked flask with an overhead condenser. The resulting mixture has been heated under reflux for 48 hours. The reaction medium has then been cooled to room temperature, filtered through a layer of silica gel (50 g) and washed with dichloromethane (DCM). The filtrate has been evaporated under reduced pressure and purified by column chromatography (8/2 cyclohexane/ethyl acetate eluent). Thionolactide has been recrystallised four times to obtain crystals in 33% yield (1.8 g). The crystals obtained have been sublimed before use in the polymerisation at 60° C. and a pressure of 10⁻² mbar.

¹H NMR (CDCl₃, 300 MHz) δ (ppm): 5.06 (q, 1H), 4.98 (q, 1H), 1.79 (d, 3H), 1.76 (d, 3H).

¹³C NMR (CDCl₃, 126 MHz) δ (ppm): 211.4, 167.5, 78.4, 75.1, 19.3, 15.5.

### 1.2 Second Step: Synthesis of Poly(Styrene-Co-Thionolactide) Copolymer CP1

6 mg (0.025 mmole) of azobis(cyanocyclohexane) (VAZO-88), 0.08 g (0.5 mmole) of thionolactide (I-1) obtained in the previous step, 0.468 g (4.5 mmoles) of styrene, and 10 mg of naphthalene as an internal standard have been mixed to form a solution. The thionolactide (monomer of formula (I-1)) represents 10% (by mole) relative to the styrene (monomer of formula (II)). The solution has been transferred to a Carius tube which has been sealed under vacuum after three degassing cycles. The tube has then been placed in an oil bath at 100° C. for 5 hours. Polymerisation has been stopped by rapid cooling. After opening the tube, part of the solution has been transferred to an NMR tube to determine conversion of thionolactide (I-1) after 5 h of reaction.

The conversion to monomer has been determined by hydrogen nuclear magnetic resonance (¹H NMR). To do this, the signal at 7.8 ppm of naphthalene as an internal standard has been integrated as corresponding to 1 and has been compared with a signal at 5.10-4.95 ppm which corresponds to two hydrogen atoms of thionolactide (I-1) and compared with the result of the integral at a reaction time equal to 0 hour. The conversion of thionolactide (I-1) after a reaction time of X hours can thus be determined according to the following equation 1:

$$Conversion ( I - 1 ) = 1 - \frac{{\int }_{4.9}^{5.1} ( I - 1 ) ( X h )}{{\int }_{4.9}^{5.1} ( I - 1 ) ( 0 h )}$$

The conversion to monomer, determined by hydrogen nuclear magnetic resonance (¹H NMR), was 58% for thionolactide (I-1) and 82% for styrene. The residual monomers have been evaporated and the number average molar mass (Mn), as well as the polymolecularity index (Mw/Mn) of the copolymer CP1 have been measured by steric exclusion chromatography (eluent: tetrahydrofuran THF) with a PMMA-based calibration curve: Mn=13200 g/mol; Mw/Mn=2.3.

### Example 2: Synthesis of a Degradable Copolymer CP2 Based on Tert-Butyl Acrylate and Thionolactide of Formula (I-1) According to the Method of the Invention

5.3 mg (0.022 mmole) of azobis(cyanocyclohexane) (VAZO-88), 0.07 g (0.44 mmole) of thionolactide (I-1) obtained in example 1, 0.504 g (3.9 mmoles) of tert-butyl acrylate, and 10 mg of naphthalene as an internal standard have been mixed to form a solution. The thionolactide (monomer of formula (I-1)) represents 10% (by mole) relative to the tert-butyl acrylate (monomer of formula (II)). The solution has been transferred to a Carius tube which has been sealed under vacuum after three degassing cycles. The tube has then been placed in an oil bath at 100° C. for 5 hours. Polymerisation has been stopped by rapid cooling. After opening the tube, part of the solution has been transferred to an NMR tube to determine conversion of thionolactide (I-1) after 5 h of reaction.

The conversion to monomer, determined by hydrogen nuclear magnetic resonance (¹H NMR), as explained in example 1 was 34% for thionolactide (I-1) and 33% for tert-butyl acrylate. The residual monomers have been evaporated and the number average molar mass (Mn), as well as the polymolecularity index (Mw/Mn) of the poly(tert-butyl acrylate-co-thionolactide) copolymer CP2 have been measured by steric exclusion chromatography (eluent: THF) with a PMMA-based calibration curve: Mn=8000 g/mol; Mw/Mn=1.7.

### Example 3: Synthesis of a Degradable Copolymer CP3 Based on Methyl Methacrylate and Thionolactide of Formula (I-1) According to the Method of the Invention

6.1 mg (0.025 mmole) of azobis(cyanocyclohexane) (VAZO-88), 0.08 g (0.5 mmole) of thionolactide (I-1) obtained in example 1, 0.45 g (4.5 mmoles) of methyl methacrylate, and 10 mg of naphthalene as an internal standard have been mixed to form a solution. The thionolactide (monomer of formula (I-1)) represents 10% (in mole) relative to the methyl methacrylate (monomer of formula (II)). The solution has been transferred to a Carius tube which has been sealed under vacuum after three degassing cycles. The tube has then been placed in an oil bath at 100° C. for 5 hours. Polymerisation has been stopped by rapid cooling. After opening the tube, part of the solution has been transferred to an NMR tube to determine conversion of thionolactide (I-1) after 5 h of reaction.

The conversion to monomer, determined by hydrogen nuclear magnetic resonance (¹H NMR), as explained in example 1 was 10% for thionolactide (I-1) and 64% for methyl methacrylate. The residual monomers have been evaporated and the number average molar mass (Mn), as well as the polymolecularity index (Mw/Mn) of the poly(methyl methacrylate-co-thionolactide) copolymer CP3 have been measured by steric exclusion chromatography (eluent: THF) with a PMMA-based calibration curve: Mn=7000 g/mol; Mw/Mn=1.9.

### Example 4: Synthesis of a Degradable Copolymer CP4 Based on Vinyl Pivalate and Thionolactide of Formula (I-1) According to the Method of the Invention

5.4 mg (0.022 mmole) of azobis(cyanocyclohexane) (VAZO-88), 0.07 g (0.44 mmole) of thionolactide (I-1) obtained in example 1, 0.504 g (3.9 mmoles) of vinyl pivalate, and 10 mg of naphthalene as an internal standard, have been mixed to form a solution. The thionolactide (monomer of formula (I-1)) represents 10% (by mole) relative to the vinyl pivalate (monomer of formula (II)). The solution has been transferred to a Carius tube which has been sealed under vacuum after three degassing cycles. The tube has then been placed in an oil bath at 70° C. for 16 hours. Polymerisation has been stopped by rapid cooling. After opening the tube, part of the solution has been transferred to an NMR tube to determine conversion of thionolactide (I-1) after 16 hours of reaction.

The conversion to monomer, determined by hydrogen nuclear magnetic resonance (¹H NMR), as explained in example 1 was 100% for thionolactide (I-1) and 64% for vinyl pivalate. The residual monomers have been evaporated and the number average molar mass (Mn), as well as the polymolecularity index (Mw/Mn) of the poly(vinyl pivalate-co-thionolactide) copolymer CP4 have been measured by steric exclusion chromatography (eluent: THF) with a PMMA-based calibration curve: Mn=12100 g/mol; Mw/Mn=2.1.

### Example 5: Chemical Degradation of a Degradable Copolymer CP2 Based on Tert-Butyl Acrylate and Thionolactide of Formula (I-1)

10 mg of the copolymer CP2 from example 2 have been diluted in 1 mL of THF and 1 mL of a bleach solution (aqueous NaOCl solution comprising 11-15% active chlorine) has been added. The resulting mixture has been kept under stirring in a sealed tube for 14 days at room temperature. The solvent has been evaporated under reduced pressure, and then the residue has been dissolved in THF and analysed by steric exclusion chromatography.

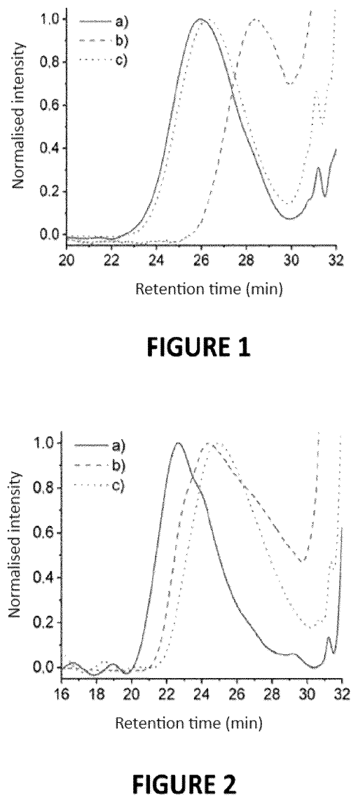

FIG. 1 shows the behaviour of CP2 in relative Δn value (i.e. difference between the refractive index of the sample analysed and that of the solvent) as a function of retention time (in min) before contacting with bleach (CP2 in THF, Mn=8000 g/mol, Mw/Mn=1.7, FIG. 1a), the residue obtained after contacting CP2 with bleach (Mn=2100 g/mol, Mw/Mn=1.5, FIG. 1b), and CP2 diluted in THF and left at room temperature for 30 days (Mn=6400 g/mol, Mw/Mn=2.0, FIG. 1c).

It appears that after degradation of the copolymer CP2 by bleach, the molar mass distribution is strongly shifted into the low molar mass range compared to the pre-treatment copolymer, demonstrating degradation of the backbone resulting from the presence of the thioester linkages.

### Example 6: Synthesis of a Degradable Copolymer CP5 Based on n-Butyl Acrylate and Thionolactide of Formula (I-1) According to the Method of the Invention

4.3 mg (0.022 mmole) of azobis(isobutyronitrile) (AIBN), 0.07 g (0.44 mmole) of thionolactide (I-1) obtained in example 1, 0.504 g (3.9 mmoles) of n-butyl acrylate, and 10 mg of naphthalene as an internal standard have been mixed to form a solution. The thionolactide (monomer of formula (I-1)) represents 10% (by mole) relative to the n-butyl acrylate (monomer of formula (II)). The solution has been transferred to a Carius tube which has been sealed under vacuum after three degassing cycles. The tube has then been placed in an oil bath at 70° C. for 3 hours. Polymerisation has been stopped by rapid cooling. After opening the tube, part of the solution has been transferred to an NMR tube to determine conversion of thionolactide (I-1).

The conversion to monomer, determined by hydrogen nuclear magnetic resonance (¹H NMR), as explained in example 1 was 41% for thionolactide (I-1) and 87% for n-butyl acrylate. The residual monomers have been evaporated and the number average molar mass (Mn), as well as the polymolecularity index (Mw/Mn) of the poly(n-butyl acrylate-co-thionolactide) copolymer CP5 have been measured by steric exclusion chromatography (eluent: THF) with a PMMA-based calibration curve: Mn=98000 g/mol; Mw/Mn=1.7.

### Example 7: Synthesis of a Degradable Copolymer CP6 Based on Tert-Butyl Acrylate and Dithionolactide of Formula (I-2) According to the Method of the Invention

### 7.1 First Step: Synthesis of Dithionolactide of Formula (I-2)

P₄S₁₀ (13 mmoles, 5.8 g), racemic lactide (34.9 mmoles, 5 g), hexamethyldisiloxane (HMDSO) (86.9 mmoles, 14.1 g) and 50 mL of anhydrous acetonitrile have been introduced into a two-necked flask with an overhead condenser. The resulting mixture has been heated under reflux for 48 hours. The reaction medium has then been cooled to room temperature, filtered through a layer of silica gel (50 g) and washed with dichloromethane (DCM). The filtrate has been evaporated under reduced pressure and purified by column chromatography (eluent: 8/2 cyclohexane/ethyl acetate). Dithionolactide (I-2) has been recrystallised four times to obtain crystals in 2% yield (0.1 g). The crystals obtained have been sublimed before use in the polymerisation at 60° C. and a pressure of 10⁻² mbar.

¹H NMR (CDCl₃, 300 MHz) δ (ppm): 5.05 (q, 6.3 Hz, 2H), 1.8 (d, 6.3 Hz, 6H).

¹³C NMR (CDCl₃, 126 MHz) δ (ppm): 211.2, 78.6, 19.5.

### 7.2 Second Step: Synthesis of the Degradable Copolymer CP6 Based on Tert-Butyl Acrylate and Dithionolactide of Formula (I-2) According to the Method of the Invention

5.3 mg (0.022 mmole) of azobis(cyanocyclohexane) (VAZO-88), 0.04 g (0.22 mmole) of dithionolactide (I-2) obtained in example 7.1, 0.552 g (4.3 mmoles) of tert-butyl acrylate, and 10 mg of naphthalene as an internal standard have been mixed to form a solution. The dithionolactide (monomer of formula (I-2)) represents 5% (by mole) relative to the tert-butyl acrylate (monomer of formula (II)). The solution has been transferred to a Carius tube which has been sealed under vacuum after three degassing cycles. The tube has then been placed in an oil bath at 100° C. for 5 hours. Polymerisation has been stopped by rapid cooling. After opening the tube, part of the solution has been transferred to an NMR tube to determine conversion of dithionolactide (I-2) after 5 h of reaction.

The conversion to monomer has been determined by hydrogen nuclear magnetic resonance (¹H NMR). To do this, the signal at 7.8 ppm of naphthalene as an internal standard has been integrated as corresponding to 1 and has been compared with a signal at 5.0-5.1 ppm which corresponds to two hydrogen atoms of dithionolactide (I-2) and compared with the result of the integral at a reaction time equal to 0 hour. The conversion of dithionolactide (I-2) after a reaction time of X hours can thus be determined according to the following equation 2:

$$Conversion ( I - 2 ) = 1 - \frac{{\int }_{5.}^{5.1} ( I - 2 ) ( X h )}{{\int }_{5.}^{5.1} ( I - 2 ) ( 0 h )}$$

The conversion to monomer, determined by hydrogen nuclear magnetic resonance (¹H NMR), was 100% for dithionolactide (I-2) and 98% for tert-butyl acrylate. The residual monomers have been evaporated and the number average molar mass (Mn), as well as the polymolecularity index (Mw/Mn) of the poly(tert-butyl acrylate-co-thionolactide) copolymer CP6 have been measured by steric exclusion chromatography (eluent: THF) with a PMMA-based calibration curve: Mn=28300 g/mol; Mw/Mn=2.5.

### Example 8: Chemical Degradation of a Degradable Copolymer CP6 Based on Tert-Butyl Acrylate and Dithionolactide of Formula (I-2)

10 mg of the copolymer CP6 from example 7 have been diluted in 1 mL of THF and 1 mL of a bleach solution (aqueous NaOCl solution comprising 11-15% active chlorine) has been added. The resulting mixture has been kept under stirring in a sealed tube for 14 days at room temperature. The solvent has been evaporated under reduced pressure, and then the residue has been dissolved in THF and analysed by steric exclusion chromatography.

10 mg of the copolymer CP6 from example 7 have been diluted in 1 mL of THF and 1 mL of isopropylamine solution has been added. The resulting mixture has been kept under stirring in a sealed tube for 30 days at room temperature. The solvent and isopropylamine have been evaporated under reduced pressure, then the residue has been dissolved in THF and analysed by steric exclusion chromatography.

FIG. 2 shows the behaviour of CP6 in relative Δn value (i.e. difference between the refractive index of the sample analysed and that of the solvent) as a function of retention time (in min) before contacting with bleach and isopropyl amine (Mn=28300 g/mol; Mw/Mn=2.5. FIG. 2a), the residue obtained after contacting CP6 with bleach (Mn=7700 g/mol, Mw/Mn=3.5, FIG. 2b), and the residue obtained after contacting CP6 with isopropylamine (Mn=8200 g/mol, Mw/Mn=2.8, FIG. 2c).

It appears that after degradation of the copolymer CP6 either by bleach or by isopropylamine, the molar mass distribution is strongly shifted towards the low molar mass range compared with the pre-treatment copolymer, demonstrating degradation of the backbone resulting from the presence of the thioester linkages.

### Example 9: Synthesis of a Degradable Copolymer CP7 Based on Methyl Methacrylate and Dithionolactide of Formula (I-2) According to the Method of the Invention

5.5 mg (0.023 mmole) of azobis(cyanocyclohexane) (VAZO-88), 0.04 g (0.23 mmole) of dithionolactide (I-2) obtained in example 7.1, 0.43 g (4.3 mmoles) of methyl methacrylate, and 10 mg of naphthalene as an internal standard, have been mixed to form a solution. The dithionolactide (monomer of formula (I-2)) represents 5% (by mole) relative to the methyl methacrylate (monomer of formula (II)). The solution has been transferred to a Carius tube which has been sealed under vacuum after three degassing cycles. The tube has then been placed in an oil bath at 100° C. for 5 hours. Polymerisation has been stopped by rapid cooling. After opening the tube, part of the solution has been transferred to an NMR tube to determine conversion of the dithionolactide (I-2) after 5 h of reaction.

The conversion to monomer, determined by hydrogen nuclear magnetic resonance (¹H NMR), as explained in example 7.2, was 20% for dithionolactide (I-2) and 80% for methyl methacrylate. The residual monomers have been evaporated and the number average molar mass (Mn), as well as the polymolecularity index (Mw/Mn) of the poly(methyl methacrylate-co-dithionolactide) copolymer CP7 have been measured by steric exclusion chromatography (eluent: THF) with a PMMA-based calibration curve: Mn=15000 g/mol; Mw/Mn=2.7.

### Example 10: Synthesis of Thionolactide of Formula (I-3)

P₄S₁₀ (10.7 mmoles, 4.8 g), glycolide (34.9 mmoles, 5 g), hexamethyldisiloxane (HMDSO) (72 mmoles, 11.7 g) and 50 mL of anhydrous acetonitrile have been added to a two-necked flask with an overhead condenser. The resulting mixture has been heated under reflux for 5 hours. The reaction medium has then been cooled to room temperature and the solvent evaporated. The product has been purified a first time by column chromatography (dichloromethane eluent), then the fractions collected have been purified again by column chromatography (50 g silica gel, eluent: 30% ethyl ether/70% petroleum ether) to give a yield of 20% (1.1 g).

¹H NMR (CDCl₃, 300 MHz) δ (ppm): 5.2 (s, 4H).

¹³C NMR (CDCl₃, 126 MHz) δ (ppm): 206, 165, 78, 73.

### Example 11: Synthesis of a Degradable Copolymer CP8 Based

on tert-butyl acrylate and thionolactide of formula (I-13) according to the method of the invention

### 11.1 First Step: Synthesis of 3,3-Dimethylglycolide

9.2 g (88.5 mmoles) of alphahydroxyisobutyric acid and 10 g of chloroacetyl chloride (88.5 mmoles) have been added to 20 mL of anhydrous acetonitrile in a two-necked flask with an overhead condenser. The mixture has been heated to 80° C. with stirring overnight. After cooling to room temperature, the reaction mixture has been diluted with 200 mL acetonitrile and 17.9 g triethylamine (177 mmoles) have been added dropwise. The resulting solution has then been heated to 80° C. for 6 hours. After filtration, the product has been obtained by evaporation of the solvent in 40% yield (5.1 g).

¹H NMR (CDCl₃, 300 MHz): δ (ppm): 1.67 (s, 6H); 5.01 (s, 2H).

¹³C NMR (CDCl₃, 126 MHz) δ (ppm): 167, 164, 75, 73, 24.

### 11.2 Second Step: Synthesis of the Thionolactide 3,3-Dimethylthioglycolide of Formula (I-13)

P₄S₁₀ (8.7 mmoles, 3.9 g), the 2,2-dimethylglycolide from example 11.1 (34.7 mmoles, 5 g), hexamethyldisiloxane (HMDSO) (58.0 mmoles, 9.4 g) and 50 mL of anhydrous toluene have been introduced into a two-necked flask with an overhead condenser, the whole being inerted by bubbling argon. The resulting mixture has been heated under reflux for 24 hours. The reaction medium has then been cooled to room temperature, and then the solvent evaporated. The product has been purified a first time by column chromatography (dichloromethane eluent), then the fractions collected have been purified again by column chromatography (50 g silica gel, eluent: 30% ethyl ether/70% petroleum ether) to obtain a yield of 20% (1.8 g).

¹H NMR (CDCl₃, 300 MHz): 5.2 ppm (s, 2H), 1.76 ppm (s, 6H).

¹³C NMR (CDCl₃, 126 MHz): 206.2, 167.7, 82.5, 73.8, 25.2.

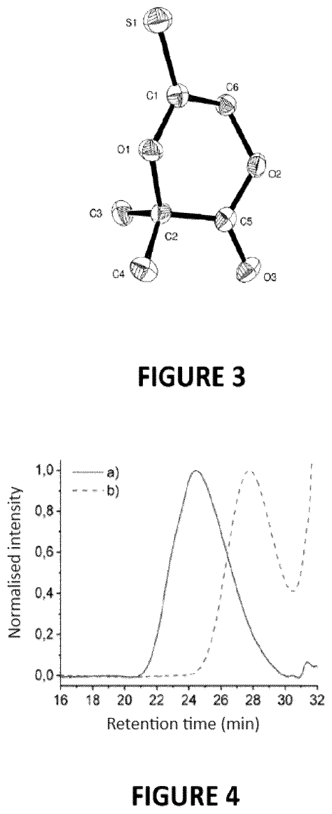

FIG. 3 illustrates the crystal structure of thionolactide (I-13).

### 11.3 Third Step: Synthesis of the Degradable Copolymer CP8 Based on Tert-Butyl Acrylate and Thionolactide of Formula (I-13) According to the Method of the Invention

5.3 mg (0.022 mmole) of azobis(cyanocyclohexane) (VAZO-88), 0.07 g (0.44 mmole) of thionolactide (I-13) obtained in example 11.2, 0.504 g (3.9 mmoles) of tert-butyl acrylate, and 10 mg of naphthalene as an internal standard, have been mixed to form a solution. The thionolactide (monomer of formula (I-13)) represents 10% (by mole) relative to the tert-butyl acrylate (monomer of formula (II)). The solution has been transferred to a Carius tube which has been sealed under vacuum after three degassing cycles. The tube has then been placed in an oil bath at 100° C. for 5 hours. Polymerisation has been stopped by rapid cooling. After opening the tube, part of the solution has been transferred to an NMR tube to determine conversion of thionolactide (I-13) after 5 h of reaction.

The conversion to monomer has been determined by hydrogen nuclear magnetic resonance (¹H NMR). To do this, the signal at 7.8 ppm from naphthalene as an internal standard has been integrated as corresponding to 1 and has been compared with a signal at 5.3-5.1 ppm that corresponds to two hydrogen atoms from thionolactide (I-13) and compared with the result of the integral at a reaction time equal to 0 hour. The conversion of thionolactide (I-13) after a reaction time of X hours can thus be determined according to the following equation 3:

$$Conversion ( I - 13 ) = 1 - \frac{{\int }_{4.9}^{5.1} ( I - 13 ) ( X h )}{{\int }_{4.9}^{5.1} ( I - 13 ) ( 0 h )}$$

The conversion to monomer, determined by hydrogen nuclear magnetic resonance (¹H NMR) was 44% for thionolactide (I-13) and 82% for tert-butyl acrylate. The residual monomers have been evaporated and the number average molar mass (Mn), as well as the polymolecularity index (Mw/Mn) of the poly(tert-butyl acrylate-co-thionolactide) copolymer CP8 have been measured by steric exclusion chromatography (eluent: THF) with a PMMA-based calibration curve: Mn=13800 g/mol; Mw/Mn=2.4.

### Example 12: Chemical Degradation of a Degradable Copolymer CP8 Based on Tert-Butyl Acrylate and Thionolactide of Formula (I-13)

10 mg of the copolymer CP8 from example 11.3 have been diluted in 1 mL of THF and 1 mL of a bleach solution (aqueous NaOCl solution comprising 11-15% active chlorine) has been added. The resulting mixture has been kept under stirring in a sealed tube for 14 days at room temperature. The solvent has been evaporated under reduced pressure, and then the residue has been dissolved in THF and analysed by steric exclusion chromatography.

FIG. 4 shows the behaviour of CP8 before degradation in relative Δn value (i.e. the difference between the refractive index of the sample analysed and that of the solvent) as a function of retention time (in min) (CP8 in THF, Mn=13800 g/mol; Mw/Mn=2.4, FIG. 4a), and the residue obtained after contacting CP2 with bleach (Mn=3300 g/mol, Mw/Mn=1.6, FIG. 4b).

It appears that after degradation of the copolymer CP8 by bleach, the molar mass distribution is strongly shifted towards the low molar mass range compared with the pre-treatment copolymer, demonstrating degradation of the backbone resulting from the presence of the thioester linkages.

### Example 13: Synthesis of a Degradable Copolymer CP9 Based on Methyl Methacrylate and Thionolactide of Formula (I-13) According to the Method of the Invention

6.1 mg (0.025 mmol) of azobis(cyanocyclohexane) (VAZO-88), 0.08 g (0.5 mmol) of thionolactide (I-13) obtained in example 11.2, 0.45 g (4.5 mmol) of methyl methacrylate, and 10 mg of naphthalene as an internal standard have been mixed to form a solution. The thionolactide (monomer of formula (I-13)) represents 10% (by mole) relative to the methyl methacrylate (monomer of formula (II)). The solution has been transferred to a Carius tube which has been sealed under vacuum after three degassing cycles. The tube has then been placed in an oil bath at 100° C. for 5 hours. Polymerisation has been stopped by rapid cooling. After opening the tube, part of the solution has been transferred to an NMR tube to determine conversion of thionolactide (I-13) after 5 h of reaction.

The conversion to monomer, determined by hydrogen nuclear magnetic resonance (¹H NMR), as explained in example 11.2 was 25% for thionolactide (I-13) and 90% for methyl methacrylate. The residual monomers have been evaporated and the number average molar mass (Mn), as well as the polymolecularity index (Mw/Mn) of the poly(methyl methacrylate-co-thionolactide) copolymer CP9 have been measured by steric exclusion chromatography (eluent: THF) with a PMMA-based calibration curve: Mn=13900 g/mol; Mw/Mn=2.0.

### Example 14: Synthesis of a Degradable Copolymer CP10 Based on Tert-Butyl Acrylate and Thionolactide of Formula (I-14) According to the Method of the Invention

### 14.1 First Step: Synthesis of 3,3,6-Trimethylglycolide

8.2 g (78.7 mmoles) of alpha-hydroxyisobutyric acid and 10 g of chloropropyl chloride (78.7 mmoles) have been added to 20 mL of anhydrous acetonitrile in a two-necked flask with an overhead condenser. The mixture has been heated to 80° C. with stirring overnight. After cooling to room temperature, the reaction mixture has been diluted with 200 mL acetonitrile and then 15.9 g triethylamine (157.5 mmoles) have been added dropwise. The resulting solution has then been heated to 80° C. for 6 hours. After filtration, the product has been obtained by evaporation of the solvent in 40% yield (4.4 g).

¹H NMR (CDCl₃, 300 MHz) δ (ppm): 1.68 (m, 9H); 5.09 (q, 7.2 Hz, 1H).

¹³C NMR (CDCl₃, 126 MHz) δ (ppm): 168.8, 166.8, 80.7, 73.1, 26.4, 25.4, 17.6.

### 14.2 Second Step: Synthesis of the Thionolactide 3,3,6-Trimethylthioglycolide of Formula (I-14)

P₄S₁₀ (4.7 mmoles, 2.1 g), the 2,2-dimethylglycolide from example 14.1 (19 mmoles, 3 g), hexamethyldisiloxane (HMDSO) (31.7 mmoles, 5.1 g) and 50 mL of anhydrous toluene have been introduced into a two-necked flask with an overhead refrigerant, the whole being inerted by bubbling argon. The resulting mixture has been heated under reflux for 24 hours. The reaction medium has then been cooled to room temperature, and then the solvent evaporated. The product has been purified a first time by column chromatography (dichloromethane eluent), and then the fractions collected have been purified again by column chromatography (50 g silica gel, eluent: 20% ethyl ether/80% petroleum ether) to obtain a yield of 25% (0.8 g).

¹H NMR (CDCl₃, 300 MHz): 5.2 (q, 6.6 Hz, 1H), 1.87 (d, 6.6 Hz, 3H), 1.79 (s, 6H).

¹³C NMR (CDCl₃, 126 MHz): 211.4, 169.0, 83.2, 79.6, 24.7, 21.5.

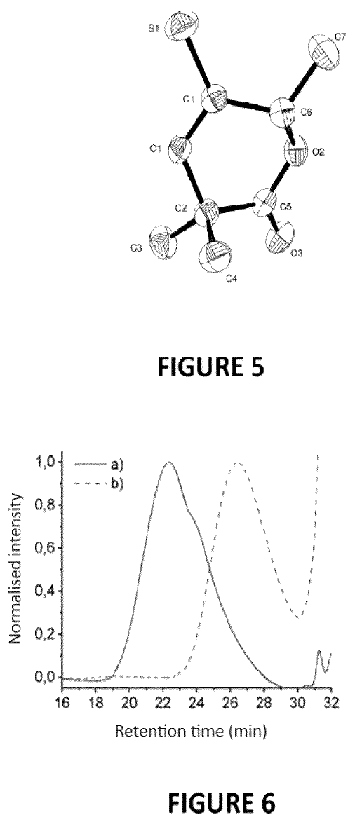

FIG. 5 illustrates the crystal structure of the thiolactide (I-14).

### 14.3 Third Step: Synthesis of the Degradable Copolymer CP10 Based on Tert-Butyl Acrylate and Thionolactide of Formula (I-14) According to the Method of the Invention

5 mg (0.02 mmole) of azobis(cyanocyclohexane) (VAZO-88), 0.07 g (0.40 mmole) of thionolactide (I-14) obtained in example 14.2, 0.464 g (3.6 mmoles) of tert-butyl acrylate, and 10 mg of naphthalene as an internal standard have been mixed to form a solution. The thionolactide (monomer of formula (I-14)) represents 10 mol % relative to the tert-butyl acrylate (monomer of formula (II)). The solution has been transferred to a Carius tube which has been sealed under vacuum after three degassing cycles. The tube has then been placed in an oil bath at 100° C. for 5 hours. Polymerisation has been stopped by rapid cooling. After opening the tube, part of the solution has been transferred to an NMR tube to determine conversion of thionolactide (I-14) after 5 h of reaction.

The conversion to monomer has been determined by hydrogen nuclear magnetic resonance (¹H NMR). To do this, the signal at 7.8 ppm from naphthalene as an internal standard has been integrated as corresponding to 1 and has been compared with a signal at 5.1-4.9 ppm that corresponds to two hydrogen atoms from thionolactide (I-14) and compared with the result of the integral at a reaction time equal to 0 hour. The conversion of thionolactide (I-14) after a reaction time of X hours can thus be determined according to the following equation 4:

$$Conversion ( I - 14 ) = 1 - \frac{{\int }_{4.9}^{5.1} ( I - 14 ) ( X h )}{{\int }_{4.9}^{5.1} ( I - 14 ) ( 0 h )}$$

The conversion to monomer, determined by hydrogen nuclear magnetic resonance (¹H NMR) was 26% for thionolactide (I-14) and 52% for tert-butyl acrylate. The residual monomers have been evaporated and the number average molar mass (Mn), as well as the polymolecularity index (Mw/Mn) of the poly(tert-butyl acrylate-co-thionolactide) copolymer CP10 have been measured by steric exclusion chromatography (eluent: THF) with a PMMA-based calibration curve: Mn=13500 g/mol; Mw/Mn=4.2.

### Example 15: Chemical Degradation of a Degradable Copolymer CP10 Based on Tert-Butyl Acrylate and Thionolactide of Formula (I-14)

10 mg of the copolymer CP10 from example 14.3 have been diluted in 1 mL of THF and 1 mL of a bleach solution (aqueous NaOCl solution comprising 11-15% active chlorine) has been added. The resulting mixture has been kept under stirring in a sealed tube for 14 days at room temperature. The solvent has been evaporated under reduced pressure, and then the residue has been dissolved in THF and analysed by steric exclusion chromatography.

FIG. 6 shows the behaviour of CP10 in relative Δn value (i.e. difference between the refractive index of the sample analysed and that of the solvent) as a function of retention time (in min) before contacting with bleach (CP10 in THF, Mn=13500 g/mol; Mw/Mn=3.8, FIG. 6a), and of the residue obtained after contacting CP10 with bleach (Mn=5700 g/mol, Mw/Mn=1.9, FIG. 6b).

It appears that after degradation of the copolymer CP10 by bleach, the molar mass distribution is strongly shifted into the low molar mass range compared with the pre-treatment copolymer, demonstrating degradation of the backbone resulting from the presence of the thioester linkages.

### Example 16: Synthesis of a Degradable Copolymer CP11 Based on Methyl Methacrylate and Thionolactide of Formula (I-14) According to the Method of the Invention

5.6 mg (0.023 mmole) of azobis(cyanocyclohexane) (VAZO-88), 0.08 g (0.46 mmole) of thionolactide (I-14) obtained in example 14.2, 0.414 g (4.6 mmoles) of methyl methacrylate, and 10 mg of naphthalene as an internal standard have been mixed to form a solution. The thionolactide (monomer of formula (I-14)) represents 10% (by mole) relative to the methyl methacrylate (monomer of formula (II)). The solution has been transferred to a Carius tube which has been sealed under vacuum after three degassing cycles. The tube has then been placed in an oil bath at 100° C. for 5 hours. Polymerisation has been stopped by rapid cooling. After opening the tube, part of the solution has been transferred to an NMR tube to determine conversion of thionolactide (I-14) after 5 h of reaction.

The conversion to monomer, determined by hydrogen nuclear magnetic resonance (¹H NMR), as explained in example 14.3 was 15% for thionolactide (I-14) and 28% for methyl methacrylate. The residual monomers have been evaporated and the number average molar mass (Mn), as well as the polymolecularity index (Mw/Mn) of the poly(methyl methacrylate-co-thionolactide) copolymer CP11 have been measured by steric exclusion chromatography (eluent: THF) with a PMMA-based calibration curve: Mn=2400 g/mol; Mw/Mn=1.4.

### Example 17: Synthesis of a Degradable Copolymer CP12 Based on Styrene and Thionolactide of Formula (I-14) According to the Method of the Invention

5 mg (0.020 mmole) of azobis(cyanocyclohexane) (VAZO-88), 0.07 g (0.4 mmole) of thionolactide (I-14) obtained in example 14.2, 0.377 g (3.6 mmoles) of styrene, and 10 mg of naphthalene as an internal standard have been mixed to form a solution. The thionolactide (monomer of formula (I-14)) represents 10% (by mole) relative to the styrene (monomer of formula (II)). The solution has been transferred to a Carius tube which has been sealed under vacuum after three degassing cycles. The tube has then been placed in an oil bath at 100° C. for 5 hours. Polymerisation has been stopped by rapid cooling. After opening the tube, part of the solution has been transferred to an NMR tube to determine conversion of thionolactide (I-14) after 5 h of reaction.

The conversion to monomer, determined by hydrogen nuclear magnetic resonance (¹H NMR), as explained in example 14.3, was 26% for thionolactide (I-14) and 46% for styrene. The residual monomers have been evaporated and the number average molar mass (Mn), as well as the polymolecularity index (Mw/Mn) of the copolymer CP12 have been measured by steric exclusion chromatography (eluent: THF tetrahydrofuran) with a PMMA-based calibration curve: Mn=3700 g/mol; Mw/Mn=3.2.

1-17. (canceled)

18. A method for preparing at least one copolymer, preferably at least one degradable copolymer, said method comprising at least one step of radical polymerisation by ring opening of at least one cyclic monomer with at least one monomer comprising an ethylenic unsaturation, in the presence of a radical polymerisation initiator, wherein:
(i) the cyclic monomer is selected from thionolactides of the following formula (I): 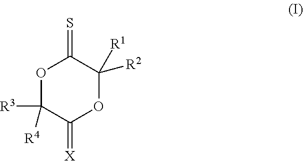
wherein:
X is an oxygen atom or a sulphur atom;
R¹, R², R³, and R⁴, independently of each other, represent a hydrogen atom, a halogen atom, a group selected from an alkyl radical, a haloalkyl radical, an optionally substituted phenyl radical, a cyano group, an optionally substituted alkyl-phenyl radical, an optionally substituted haloalkyl-phenyl radical, a carboxylic acid radical, an ester radical CO₂R⁵ with R⁵ representing an alkyl radical, a phosphonic acid radical, a phosphonic acid ester radical P(O)(OR^{6a})(OR^{6b}) with R^{6a} representing a hydrogen atom or an alkyl radical, and R^{6b} representing an alkyl radical, a sulphonic acid radical, a sulphonic acid ester radical SO₃R⁷ with R⁷ representing an alkyl radical or a haloalkyl radical, and an amide radical C(O)NR^{8a}R^{8b}, with R^{a} and R^{8b}, independently of each other, representing a hydrogen atom or an alkyl radical, or together forming an alkyl radical; and
(ii) the monomer including an ethylenic unsaturation is selected from monomers of the following formula (II): 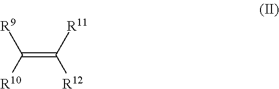
wherein:
R⁹ represents a hydrogen atom or a fluorine atom;
R¹⁰ represents a hydrogen atom or a fluorine atom;
R¹¹ represents a hydrogen atom, an alkyl radical, a fluorine atom or a chlorine atom;
R¹² represents a hydrogen atom, or a group selected from the following groups:
an alkyl radical
a haloalkyl radical
an optionally substituted aryl radical,
an optionally substituted alkyl-aryl radical,
an imidazolyl group
an alkylimidazolium group,
a carbazoyl group, and
a group of the following formula (III): 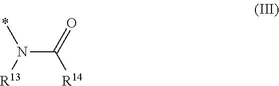
wherein the asterisk (*) represents the anchor point of the group of formula (III) to the carbon atom of the compound of formula (II), and R³ and R¹⁴, identical or different, represent a hydrogen atom, an alkyl radical, an optionally substituted alkyl-aryl radical, an optionally substituted aryl radical, a glycidyl group, or R¹³ and R¹⁴, together with the nitrogen and carbon atoms of the group of formula (III) to which they are bonded, form a heterocarbon ring comprising from 4 to 7 carbon atoms,
a —OC(O)R⁵ group, with R¹⁵ representing an alkyl radical, a haloalkyl radical, an optionally substituted alkyl-aryl radical, an optionally substituted aryl radical,
a —C(O)OR¹⁶ group, with R¹⁶ representing an alkyl radical, a haloalkyl radical, an optionally substituted alkyl-aryl radical or an optionally substituted aryl radical,
a phosphonic acid group,
a phosphonic acid ester group P(O)(OR^{17a})(OR^{17b}), with R^{17a} representing a hydrogen atom or an alkyl radical, and R^{17b} representing an alkyl radical,
a sulphonic acid group,
a sulphonic acid ester group SO₃R¹⁸, with R¹⁸ representing an alkyl radical or a haloalkyl radical, and
an amide group C(O)NR^{19a}R^{19b} with R^{19a} and R^{19b}, independently of each other, representing a hydrogen atom or an alkyl radical, or together forming an alkyl radical.

19. The method according to claim 18, wherein R¹, R², R³ and R⁴, independently of each other, represent a hydrogen atom, a halogen atom, a group selected from an alkyl radical, a haloalkyl radical, an optionally substituted phenyl radical, an optionally substituted alkyl-phenyl radical, and an optionally substituted haloalkyl-phenyl radical.

20. The method according to claim 18, wherein:
R¹=H or CH₃,
R²=H, CH₃, C₆H₅, CF₃, C₆F₅, C₆H₄—CF₃, F, CH₂F, CH₂Cl, or C₂H₄—Cl,
R³=H or CH₃,
R⁴=H, CH₃, C₆H₅, CF₃, C₆F₅, C₆H₄—CF₃, F, CH₂F, CH₂Cl, or C₂H₄—Cl.

21. The method according to claim 18, wherein the thionolactide of formula (I) is selected from the following thionolactides:
(i) the thionolactides in which R² and R⁴ are as defined in claim 1 to the exclusion of hydrogen atoms,
(ii) the thionolactides in which R³ and R⁴ are as defined in claim 1 to the exclusion of hydrogen atoms, and
(iii) the thionolactides in which R¹, R², R³ or R⁴ are hydrogen atoms.

22. The method according to claim 18, wherein the thionolactides of formula (I) are selected from the thionolactides of formulae (I-1) to (I-13) shown in the following Table 1:
TABLE 1

| | |
|---|---|
| 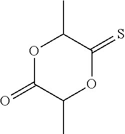 | (I-1) |
| 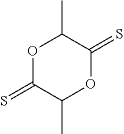 | (I-2) |
| 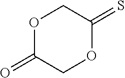 | (I-3) |
| 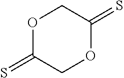 | (I-4) |
| 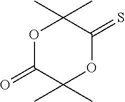 | (I-5) |
| 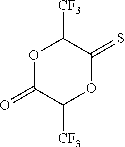 [SMILES: O=C1OC(C(F)(F)F)C(=S)OC1C(F)(F)F] | (I-6) |
| 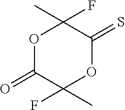 | (I-7) |
| 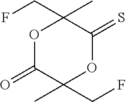 | (I-8) |
| 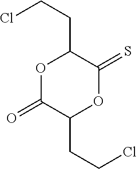 [SMILES: O=C1OC(CCCl)C(=S)OC1CCCl] | (I-9) |
| 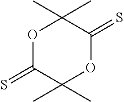 | (I-10) |
| 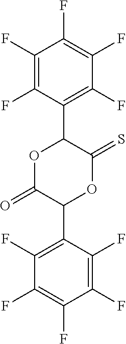 [SMILES: O=C1OC(c2c(F)c(F)c(F)c(F)c2F)C(=S)OC1c1c(F)c(F)c(F)c(F)c1F] | (I-11) |
| 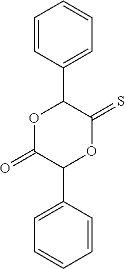 [SMILES: O=C1OC(c2ccccc2)C(=S)OC1c1ccccc1] | (I-12) |
| 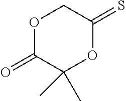 | (I-13) |
| 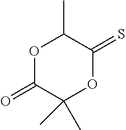 | (I-14) |

23. The method according to claim 18, wherein R⁹ represents a hydrogen atom, R¹⁰ represents a hydrogen atom, and R¹¹ represents a hydrogen atom or an alkyl radical.

24. The method according to claim 18, wherein the monomer of formula (II) is selected from:
a vinyl ester type monomers represented by the following formula (II-1): 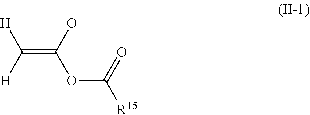
an α-olefin type monomers represented by the following formula (II-2): 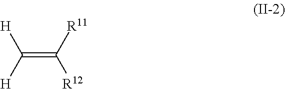
wherein R¹¹ represents a hydrogen atom or an alkyl radical, and R¹² represents an alkyl radical or an optionally substituted aryl radical,
an N-vinyl type monomers represented by the following formula (III-1): 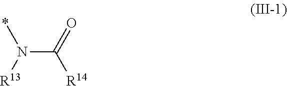
acrylate and alkacrylate type monomers represented by the following formula (II-3): 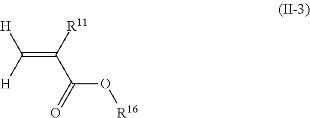
wherein R¹¹ represents a hydrogen atom or an alkyl radical and R¹⁶ represents an alkyl radical.

25. The method according to claim 18, wherein the proportion of monomers of formula (I) is selected such that the monomer or monomers of formula (I) represent at most 50% by number relative to the total number of monomers of formulae (I) and (II).

26. The method according to claim 18, wherein the step of radical polymerisation by ring opening of monomers of formulae (I) and (II) is carried out in a bulk manner or in solution in a solvent.

27. The method according to claim 18, wherein the polymerisation is carried out in a solvent and in that the total amount of monomers of formula (I) and of formula (II) ranges from 30 to 60% by mass relative to the total mass of the reaction medium.

28. The method according to claim 18, wherein the polymerisation step is carried out at a temperature ranging from 5 to 150° C.

29. A copolymer, preferably a degradable copolymer, wherein said copolymer comprises at least thioester linkages, and said copolymer results from the radical polymerisation by ring opening:
(i) of at least one cyclic monomer selected from thionolactides of the following formula (I): 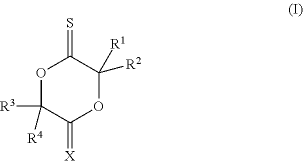
wherein:
X is an oxygen atom or a sulphur atom;
R¹, R², R³, and R⁴, independently of each other, represent a hydrogen atom, a halogen atom, a group selected from an alkyl radical, a haloalkyl radical, an optionally substituted phenyl radical, a cyano group, an optionally substituted alkyl-phenyl radical, an optionally substituted haloalkyl-phenyl radical, a carboxylic acid radical, an ester radical CO₂R⁵ with R⁵ representing an alkyl radical, a phosphonic acid radical, a phosphonic acid ester radical P(O)(OR^{6a})(OR^{6b}) with R^{6a} representing a hydrogen atom or an alkyl radical, and R^{6b} representing an alkyl radical, a sulphonic acid radical, a sulphonic acid ester radical SO₃R⁷ with R⁷ representing an alkyl radical or a haloalkyl radical, and an amide radical C(O)NR^{8a}R^{8b}, with R^{8a} and R^{8b}, independently of each other, representing a hydrogen atom or an alkyl radical, or together forming an alkyl radical; and
(ii) of at least one monomer including an ethylenic unsaturation selected from the monomers of the following formula (II): 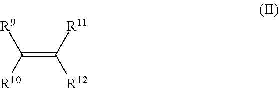
wherein:
R⁹ represents a hydrogen atom or a fluorine atom;
R¹⁰ represents a hydrogen atom or a fluorine atom;
R¹¹ represents a hydrogen atom, an alkyl radical, a fluorine atom or a chlorine atom;
R¹² represents a hydrogen atom, or a group selected from the following groups:
an alkyl radical,
a haloalkyl radical,
an optionally substituted aryl radical,
an optionally substituted alkyl-aryl radical,
an imidazolyl group,
an alkylimidazolium group,
a carbazoyl group,
a group of the following formula (III): 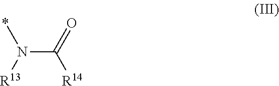
wherein the asterisk (*) represents the anchor point of the group of formula (III) to the carbon atom of the compound of formula (II), and R¹³ and R¹⁴, identical or different, represent a hydrogen atom, an alkyl radical, an optionally substituted alkyl-aryl radical, an optionally substituted aryl radical, a glycidyl group, or R¹³ and R¹⁴, together with the nitrogen and carbon atoms of the group of formula (III) to which they are bonded, form a heterocarbon ring comprising from 4 to 7 carbon atoms (including the carbon atom carrying the oxygen atom),
a —OC(O)R¹⁵ group, with R¹⁵ representing an alkyl radical, a haloalkyl radical, an optionally substituted alkyl-aryl radical, an optionally substituted aryl radical,
a —C(O)OR¹⁶ group, with R¹⁶ representing an alkyl radical, a haloalkyl radical, an optionally substituted alkyl-aryl radical or an optionally substituted aryl radical, a phosphonic acid group,
a phosphonic acid ester group P(O)(OR^{17a})(OR^{17b}), with R^{17a} representing a hydrogen atom or an alkyl radical, and R^{17b} representing an alkyl radical,
a sulphonic acid group,
a sulphonic acid ester group SO₃R¹⁸, with R¹⁸ representing an alkyl radical or a haloalkyl radical, and
an amide group C(O)NR^{19a}R^{19b}, with R^{19a} and R^{19b}, independently of each other, representing a hydrogen atom or an alkyl radical, or together forming an alkyl radical, in the presence of a radical polymerisation initiator.

30. The copolymer according to claim 29, wherein said copolymer results from the polymerisation of thionolactide (I-1): 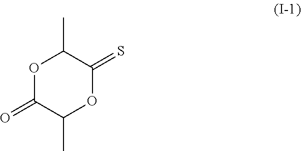
and of vinyl acetate, styrene, tert-butyl acrylate, methyl methacrylate or vinyl pivalate.

31. The copolymer according to claim 29, wherein said copolymer has a level of thioester linkages in the main chain of at least 2% by number, relative to the total number of linkages in the main chain.

32. A method of radical polymerization, comprising reacting at least one thionolactide having the formula (I) as defined in 18 as a precursor monomer.

33. A thionolactide for the implementation of the method as defined in claim 18, having the following formula (I′): 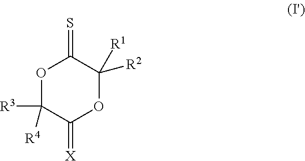
wherein:
X is an oxygen atom or a sulphur atom;
R¹, R², R³, and R⁴, independently of each other, represent a hydrogen atom, a halogen atom, a group selected from an alkyl radical, a haloalkyl radical, an optionally substituted phenyl radical, a cyano group, an optionally substituted alkyl-phenyl radical, an optionally substituted haloalkyl-phenyl radical, a carboxylic acid radical, an ester radical CO₂R⁵ with R⁵ representing an alkyl radical, a phosphonic acid radical, a phosphonic acid ester radical P(O)(OR^{6a})(OR^{6b}) with R^{6a} representing a hydrogen atom or an alkyl radical, and R^{6b} representing an alkyl radical, a sulphonic acid radical, a sulphonic acid ester radical SO₃R⁷ with R⁷ representing an alkyl radical or a haloalkyl radical, and an amide radical C(O)NR^{8a}R^{8b}, with R^{a} and R^{8b}, independently of each other, representing a hydrogen atom or an alkyl radical, or together forming an alkyl radical, and
to the exclusion of thionolactides (I-1) and (I-2):

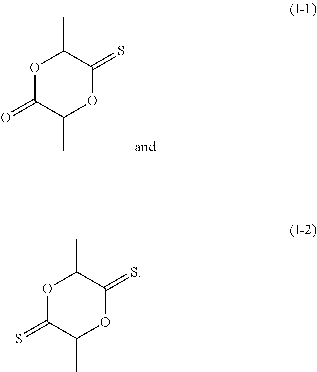

34. The thionolactide according to claim 33, selected from thionolactides of formulae (I-3) to (I-13): 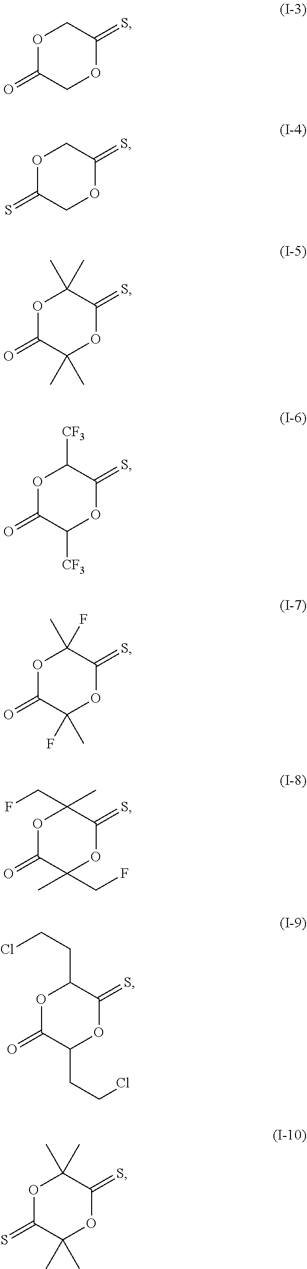 [chemical structure]
